(19) United States
(12) Patent Application Publication
(10) Pub. No.: US 2004/0265745 A1
(43) Pub. Date: Dec. 30, 2004

(54) Pattern forming method

(76) Inventors: Koutaro Sho, Yokohama-shi (JP); Tsuyoshi Shibata, Yokohama-shi (JP); Hirokazu Kato, Yokohama-shi (JP); Yasunobu Onishi, Yokohama-shi (JP); Daisuke Kawamura, Yokohama-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/839,184

(22) Filed: May 6, 2004

(30) Foreign Application Priority Data
May 9, 2003 (JP) 2003-131905
Jul. 22, 2003 (JP) 2003-199942

(51) Int. Cl. G03C 5/00

(52) U.S. Cl. 430/311

(57) ABSTRACT

A pattern forming method comprising forming a first layer on a semiconductor substrate, forming a resist layer on the first layer, patterning the resist layer to form a first patterning layer having several patterns, slimming or thickening a pattern width of the first patterning layer, forming a second patterning layer between patterns of the first patterning layer, and patterning the first patterning layer using the second patterning layer as a mask.

### CROSS-REFERENCE TO RELATED APPLICATIONS

This application is based upon and claims the benefit of priority from prior Japanese Patent Applications No. 2003-131905, filed May 9, 2003; and No. 2003-199942, filed Jul. 22, 2003, the entire contents of both of which are incorporated herein by reference.

### BACKGROUND OF THE INVENTION

1. Field of the Invention

The present invention relates to a pattern forming method in a photolithography technique used for a method of manufacturing a semiconductor device.

2. Description of the Related Art

Micro-pattern forming techniques play a major role in the semiconductor device of microfabrication. In the micro-pattern forming technique, the technological development described below has been made. In the photolithography technique using light beam, advances in the short-wavelength of light sources have been made together with the scale down. Thus, the 0.1 μm level photolithography technique has been put into practical use. In order to further micrfabrication, lithography technique using X-rays and electron beams is researched and developed as the method of overcoming the limits of light. However, the foregoing lithography is technically difficult, and lacks in adaptability to mass production. For this reason, a micro-pattern forming method exceeding the limit of resolution by wavelength is developed in the photolithography technique. An additional process such as slimming has been proposed as one of the foregoing micro-pattern forming method. In this case, the additional process such as slimming is carried out with respect to resist forming patterns after exposure and development.

For example, a resist pattern formed by the photolithography technique is made smaller, for example, slimmed down by etching. Using the formed resist pattern as a mask, the under-layer materials are patterned by dry etching. Conversely, the formed resist pattern is made large, for example, thick if narrow spaces between patterns or holes are required. For example, JPN. PAT. APLLN. KOKAI Publication No. 2002-217170 (page 6, FIG. 1) discloses the following method. According to the method, an electron beam is used, and irradiation conditions of electron beam to developed resist pattern are changed using, and thereby, the resist pattern is made both small and large.

The foregoing additional process such as slimming is employed, and thereby, a micro-pattern forming method is possible in the photolithography technique. However, the method has the following problems. More specifically, if dry etching is carried out with respect to the under-layer material using resist as a mask, etching resistance of the resist is required. However, the additional process such as slimming is carried out, and thereby, the film thickness of the remaining resist pattern is reduced. For this reason, the problem easily arises such that the etched under-layer material diverges from a desired dimension or shape. If the film thickness of the resist is made thick in order to solve the problem, a problem further arises that the resist fails, or a resist dimension and processing accuracy of the shape are reduced.

An multi-layer resist process is given as the method of solving the foregoing problems. There are many kinds of multi-layer resist processes. Here, inversion mask process is given as one example (JPN. PAT. APLLN. KOKAI Publication No. 5-267253). According to the inversion mask process, a resist has no need of dry etching resistance; therefore, it is possible to seek only resolution in the resist development. The final pattern obtained by the inversion mask process is a concavo-convex inverted resist pattern. Therefore, it is possible to readily form patterns, which are difficult to formed by the conventional pattern transfer method.

The inventors made comprehensive simulations and experiments relevant to planarization of coating films taking the following requirements into consideration. The requirements are patterns included in layers used for semiconductor manufacture, properties of etching mask materials and accuracy of semiconductor manufacture process. As a result, most of the layers used for semiconductor manufacture were broken if the conventional technique disclosed in the foregoing Publication No. 5-267253 is used as it. More specifically, patterns are not formed as desired at large resist remaining or removed pattern portions.

Thus, the inversion mask process has a problem that patterns are not formed as desired at large resist remaining or removed pattern portions.

### BRIEF SUMMARY OF THE INVENTION

According to one aspect of the present invention, there is provided a pattern forming method comprising: forming a first layer on a semiconductor substrate; forming a resist layer on the first layer; patterning the resist layer to form a first patterning layer having several patterns; slimming or thickening a pattern width of the first patterning layer; forming a second patterning layer between patterns of the first patterning layer; and patterning the first patterning layer using the second patterning layer as a mask.

According to one aspect of the present invention, there is provided a pattern forming method comprising: forming a first resist film on a first film; patterning the first resist film, in a region where a pattern of the first resist film is formed, the relation between one side length y (μm) of the maximum square region where the first resist film has 90% or more coverage. and one side length x (μm) of the maximum square region where the same has 10% or less coverage satisfying the following equation y<84.29+44.63×103x e^{-X/17.80}; forming a mask layer on the first film using spin coating, the mask layer covering the first resist film; etching back the surface of the mask layer to expose the upper surface of the first resist film; removing the first resist film after being exposed; and etching the first film using the mask layer as a mask.

According to one aspect of the present invention, there is provided a pattern forming method comprising: forming a first resist film on a first film; patterning the first resist film; forming a mask layer on the first film using spin coating, the mask layer covering the first resist film; etching back the surface of the mask layer to expose the upper surface of the first resist film; forming a second resist film covering the mask layer on the first film after the first resist film is exposed; patterning the second resist film; etching the mask layer using the patterned second resist film as a mask removing the first and second resist films after the mask layer is etched; and patterning the first film using the etched mask layer as a mask after the removal of the first and second resist films or simultaneously with the removal.

According to one aspect of the present invention, there is provided a pattern forming method comprising: forming a first resist film on a first film; patterning the first resist film; forming a mask layer on the first film using spin coating, the first resist film covering the first resist film; forming a second resist film covering the mask layer on the first film; patterning the second resist film; etching the mask layer using the patterned second resist film as a mask; removing the second resist film after the mask layer is etched; etching back the surface of the mask layer to expose the upper surface of the first resist film after the second resist film is removed; removing the exposed first resist film; and patterning the first film using the etched mask layer as a mask after the removal of the exposed first resist film or simultaneously with the removal.

### BRIEF DESCRIPTION OF THE SEVERAL VIEWS OF THE DRAWING

FIG. 1A to FIG. 1H are cross-sectional views showing the process of manufacturing a semiconductor device according to a first embodiment of the present invention;

FIG. 2A and FIG. 2B are top plan views showing the process of manufacturing a semiconductor device according to a second embodiment of the present invention;

FIG. 3 is a top plan view showing the process of manufacturing a semiconductor device according to the second embodiment of the present invention;

FIG. 4A to FIG. 4H are cross-sectional views showing the process of manufacturing a semiconductor device according to a third embodiment of the present invention;

FIG. 5A and FIG. 5B are top plan views showing the process of manufacturing a semiconductor device according to a fourth embodiment of the present invention;

FIG. 6 is a top plan view showing the process of manufacturing a semiconductor device according to the fourth embodiment of the present invention;

FIG. 7A to FIG. 7G are cross-sectional views showing the process of manufacturing a semiconductor device according to a fifth embodiment of the present invention;

FIG. 8 is a graph to explain the requirements for resist pattern;

FIG. 9A to FIG. 9H are cross-sectional views showing the process of manufacturing a semiconductor device according to a sixth embodiment of the present invention;

FIG. 10A to FIG. 10F are cross-sectional views showing a modification example of the process of manufacturing the semiconductor device according to the sixth embodiment;

FIG. 11A to FIG. 11I are cross-sectional views showing the process of manufacturing a semiconductor device according to a seventh embodiment of the present invention;

FIG. 12A to FIG. 12H are cross-sectional views showing the process of manufacturing a semiconductor device according to an eighth embodiment of the present invention;

FIG. 13A to FIG. 13H are cross-sectional views showing the process of manufacturing a semiconductor device according to a ninth embodiment of the present invention;

FIG. 14A to FIG. 14J are cross-sectional views showing the process of manufacturing a semiconductor device according to a tenth embodiment of the present invention;

FIG. 15A to FIG. 15H are cross-sectional views showing the process of manufacturing a semiconductor device according to an 11-th embodiment of the present invention;

FIG. 16A to FIG. 16F are cross-sectional views showing a modification example of the process of manufacturing the semiconductor device according to the 11-th embodiment;

FIG. 17A to FIG. 17I are cross-sectional views showing the process of manufacturing a semiconductor device according to a 12-th embodiment of the present invention;

FIG. 18A to FIG. 18J are cross-sectional views showing the process of manufacturing a semiconductor device according to a 13-th embodiment of the present invention; and

FIG. 19A to FIG. 19H are cross-sectional views showing the process of manufacturing a semiconductor device according to a 14-th embodiment of the present invention.

### DETAILED DESCRIPTION OF THE INVENTION

Embodiments of the present invention will be described below with reference to the accompanying drawings.

(First embodiment)

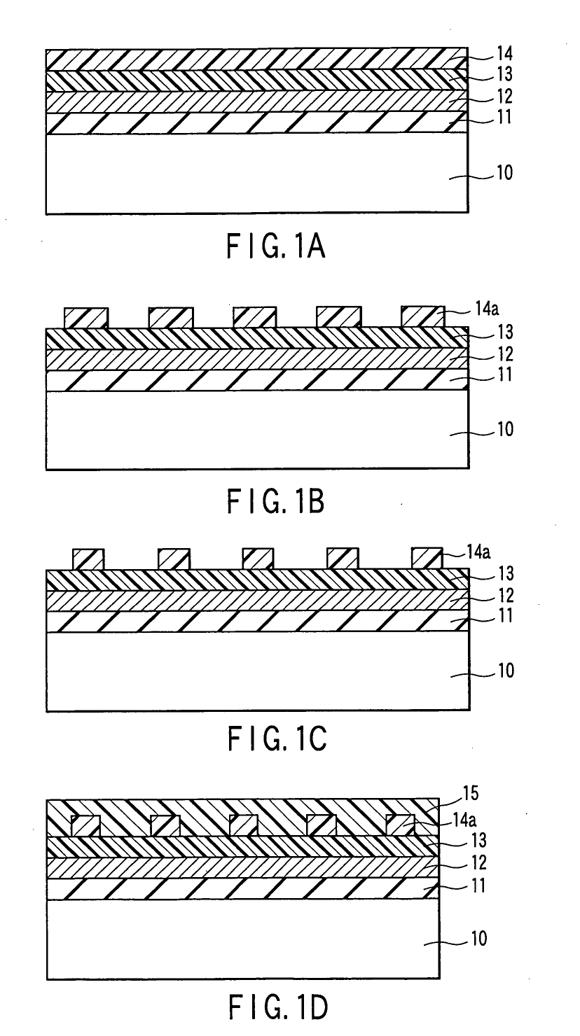

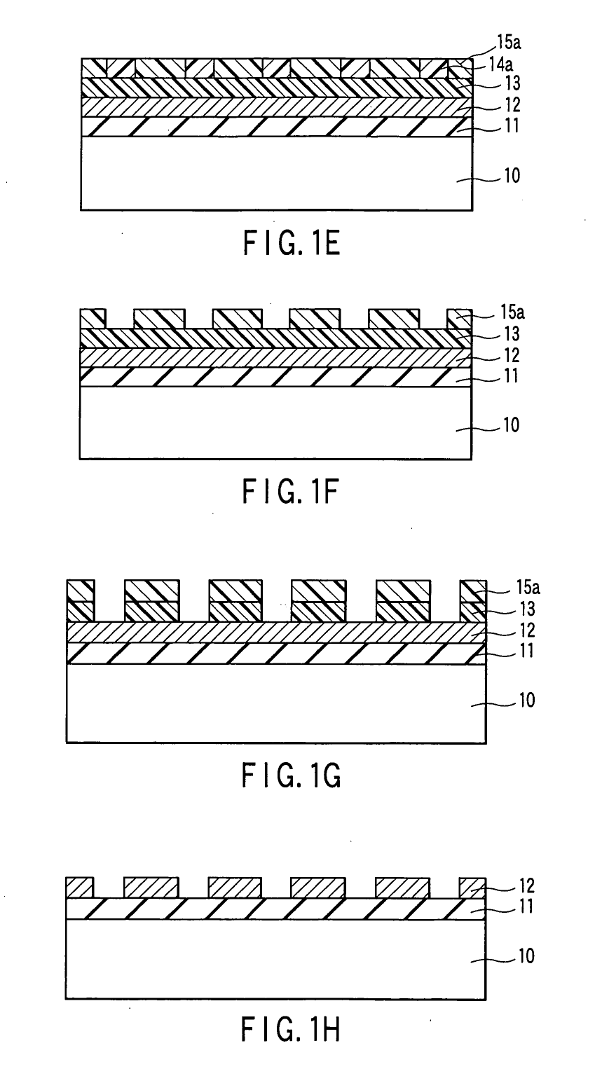

FIG. 1A to FIG. 1H are cross-sectional views showing the process of manufacturing a semiconductor device according to a first embodiment of the present invention.

A P-type silicon substrate 10 is prepared as a semiconductor substrate. A silicon oxide film 11 having a thickness of about 200 nm is formed on the silicon substrate 10 using a CVD process. A wiring (interconnection) metal, that is, Al film 12 is formed on the silicon oxide film 11 to have a thickness of about 500 nm. A polyacenaphthylene film 13 having a thickness of about 300 nm is formed on the Al film 12 using spin coating. The polyacenaphthylene film 13 is used as an etching mask of the Al film 12.

A positive DUV resist layer 14 having a thickness of about 100 nm is formed on the polyacenaphthylene film 13 using spin coating. The resist layer 14 has photosensitivity to ArF laser beam. The silicon substrate 10 formed with the resist layer 14 is baked under heat condition of temperature 100 to 200° C. for about one to two minutes.

The silicon substrate 10 coated with the resist layer 14 is set in an ArF excimer laser exposure system (aligner). Thereafter, the silicon substrate 10 is adjusted in position. An ArF laser beam passing through a photo mask is irradiated to the resist layer 14 on the silicon substrate 10 for a predetermined time. Then, the silicon substrate 10 is baked under a heat condition temperature of 100 to 200° C. for about one to two minutes. As shown in FIG. 1B, the resist layer 14 is developed in order to form a first patterning layer 14a on the silicon substrate 10. In this case, the dimension of the first patterning layer 14a, for example, line and space width are both 0.11 μm.

As illustrated in FIG. 1C, the surface of the first patterning layer 14a is treated using ozone water of about 10 ppm in order to reduce the dimension thereof. By doing so, the line width of the first patterning layer 14a is reduced to 0.05 μm.

As depicted in FIG. 1D, a buried layer 15, that is, water-soluble silicone is formed on the first patterning layer 14a using spin coating. The buried layer 15 has a thickness of about 300 nm. As seen from FIG. 1E, the surface of the buried layer 15 is polish using CMP so that a second patterning layer 15a remains in only the recess between the first patterning layers 14a. Of course, Processing by CMP is completed before the upper portion of the first patterning layer 14a is exposed, and thereafter, the remaining buried layer 15 may be etched back using dry etching.

As shown in FIG. 1F, the first patterning layer 14a is removed using solvent in order to leave the second patterning layer 15a. According to another process, the first patterning layer 14a may be collectively removed in etching the polyacenaphthylene film 13.

The foregoing processes are carried out, and thereby, basic pattern formation is completed. A pattern is transferred to under-layer films using the second patterning layer 15 formed with a pattern.

First, the polyacenaphthylene film 13 is etched using dry etching. In etching, the second patterning layer 15a is used as a mask. As illustrated in FIG. 1G, the pattern of the second patterning layer 15a is transferred to the polyacenaphthylene film 13. Thereafter, the Al film 12 is etched using dry etching. In etching, the polyacenaphthylene film 13 is used as a mask. As seen from FIG. 1H, the pattern of the polyacenaphthylene film 13 is transferred to the Al film 12. Thus, Al wiring layer having a small space width is formed.

According to the first embodiment, the silicon oxide film is formed on the silicon substrate, and thereafter, the Al wiring layer is formed thereon. In the process of manufacturing semiconductor devices such as LSI, the following process is carried out. According to the process, LSI including transistor and capacitor is formed on the silicon substrate. Thereafter, silicon oxide film is formed thereon as interlayer insulating film, and further, Al wiring layer is formed. Of course, the present embodiment is applicable to the process of manufacturing semiconductor devices such as LSI.

According to the first embodiment, the dimension of the pattern formed by photolithography technique is reduced using a chemical treatment such as ozone water treatment. In addition, the process of inverting pattern is carried out, thereby improving etching resistance. By doing so, it is possible to form micro and high-accuracy space patterns.

The surface of the substrate is treated by ozone water treatment; therefore, the adhesion between buried film and front end is improved. This serves to enable etch-back in which the buried film is hard to peel off. In the first embodiment, a chemical treatment using ozone water is employed. Even if so-called functional (eg. water dissolving hydrogen peroxide or radical oxygen) is used as another chemical treatment, the same as above is obtained.

(Modification Example of First Embodiment)

The modification example basically utilizes the same process as the first embodiment, with an additional process. The same process as the first embodiment is carried out until the first patterning layer 14a shown in FIG. 1A and FIG. 1B is formed.

As shown in FIG. 1C, the first patterning layer 14a is etched by dry etching using mixed gas of CF₄, HBr and O₂ By etching, the line dimension of the first patterning layer 14a is slimmed down to 0.05 μm. The surface of the silicon substrate 10 formed with the slimmed first patterning layer 14a is treated using silane coupling agent. This treatment serves to improve the adhesion between the buried film and front end when the buried film is formed in the next process.

The processes after the buried film is formed are the same as those shown FIG. 1D to FIG. 1H described in the first embodiment.

According to the modification example, the dimension of the pattern formed by photolithography is slimmed using dry etching, and further, the process of inverting the pattern is carried out. By doing so, it is possible to improve etching resistance, and to form micro and high-accuracy space pattern.

A surface treatment is carried out using silane coupling agent enhancing adhesion by coupling effect, and thereby, it is possible to improve the adhesion between inorganic and organic materials, that is, front end and buried film. By doing so, it is possible to provide recess structure in which the buried film is hard to peel off.

In addition, the same process as above can be carried out even if the following photo catalyst water treatment is employed as the foregoing surface treatment. According to the photo catalyst water treatment, water dispersing metal oxides, such as titanium (IV) oxide, zinc oxide or tungsten trioxide are coated on the surface of the silicon substrate. Thereafter, photo irradiation is carried out with respect to the surface to activate the front-end surface.

(Second Embodiment)

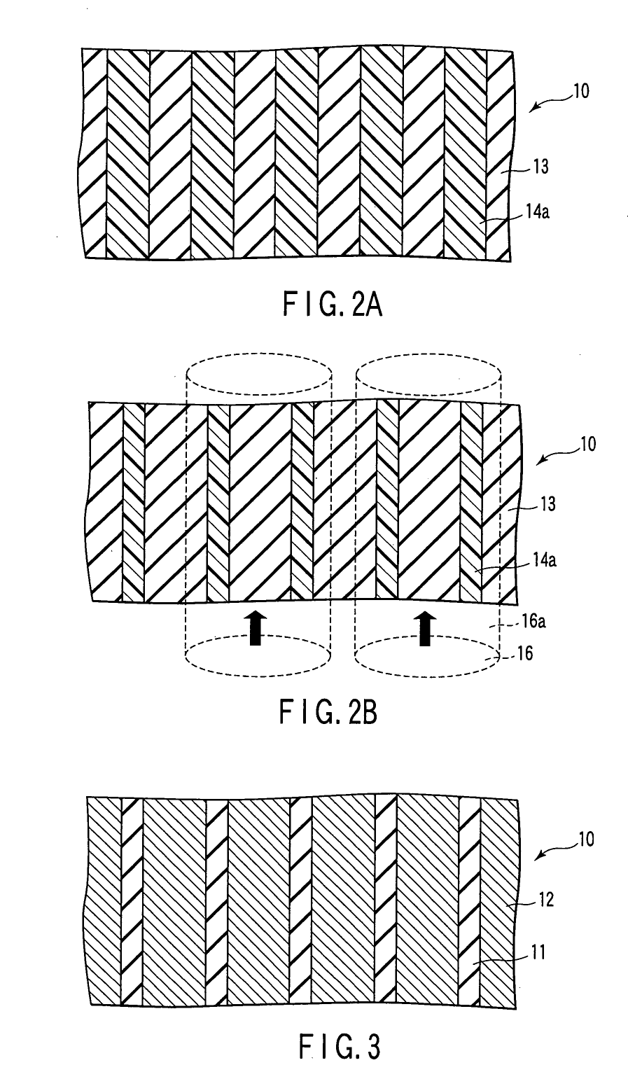

FIG. 2 and FIG. 3 are top plan views sequentially showing the process of the second embodiment.

In the first embodiment, a chemical treatment using ozone water is employed as the method of sliming the first patterning layer. According to the second embodiment, an argon ion laser beam is used as an energy beam. In the second embodiment, laser beam irradiation is carried out in place of the ozone water treatment described in FIG. 1C of the first embodiment. Other processes are the same as the first embodiment; therefore, the detailed explanation is omitted.

The same process as the process of FIG. 1A and FIG. 1B shown in the first embodiment is carried out until the P-type silicon substrate 10 shown in FIG. 2A is prepared and pattern is slimmed. FIG. 2A is a top plan view showing the silicon substrate 10 in which the first patterning layer 14a is formed on the polyacenaphthylene film 13. As illustrated in FIG. 2B, a laser beam 13 shaped by an optical system (not shown) is scanned on the silicon substrate 10 in the arrow direction. The laser beam 13 is irradiated to overlap the first patterning layer 14a in position. By doing so, the first patterning layer 14a in a laser beam scanning range is subjected to heat treatment. The heat treatment is made, and thereby, the first patterning layer 14a reacts with oxygen in the atmosphere, and thus, it is oxidized. By oxidization, the pattern dimension of the first patterning layer 14a is slimmed.

For example, the laser beam is linearly scanned from the end of the silicon substrate to the opposite end thereof. As illustrated in FIG. 2A, the laser beam 16 is shifted to the left side from the original start point. Thereafter, the laser beam 13 is scanned along the same direction as the laser beam scanning range 16a. In the manner described above, the laser beam is successively irradiated, and thereby, the width of the first patterning layer 14a is slimmed over the entire surface of wafer (not shown). In this case, laser irradiation is omitted with respect to part of the regions where the first patterning layer 14a dose not exist. By doing so, the time spent for the present process is shortened.

The processes after the dimension of the first patterning layer 14a shown in FIG. 2B is slimmed are the same as FIG. 1D to FIG. 1H described in the first embodiment. FIG. 3 is a top plan view showing the silicon substrate after the Al film 12 formed on the silicon oxide film 11 is patterned. An Al wiring layer having narrow space width is formed as in the first embodiment. In addition, the following process may be carried out. Processing by CMP is completed before the upper portion of the first patterning layer 14a is exposed, and thereafter, remaining water-soluble silicone is etched back using dry etching.

According to the second embodiment, the dimension of the pattern formed by photolithography is slimmed down using energy beam irradiation, and further, the process of inverting the pattern is carried out. By doing so, etching resistance is improved, and it is possible to form micro and high-accuracy space patterns. According to the second embodiment, laser irradiation is possible with respect to only regions where resist mask is formed without irradiating laser to the entire surface of the silicon substrate. Therefore, manufacture process efficiency is enhanced.

Any of excimer laser, carbon dioxide laser, neodymium YAG laser may be used as the laser beam in addition to argon ion laser. An electron beam or X-ray beam may be used as a energy beam in addition to the laser beam.

(Third Embodiment)

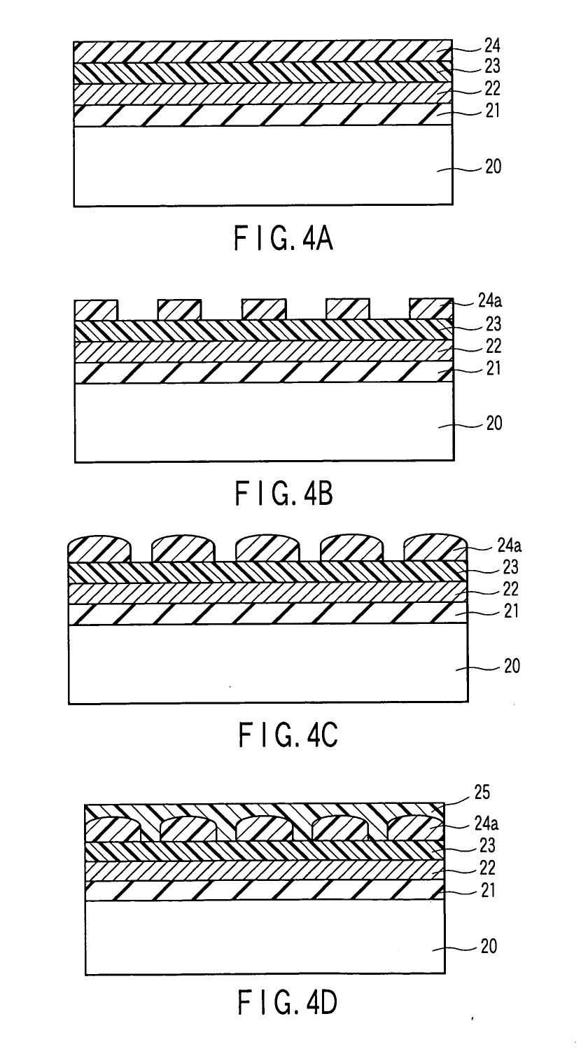

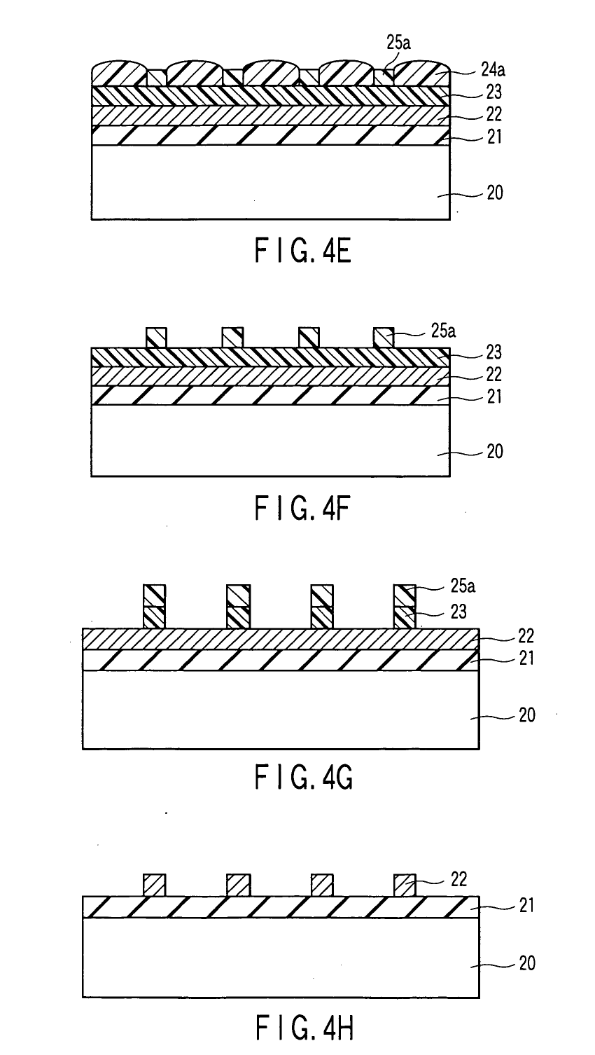

FIG. 4A to FIG. 4H are cross-sectional views showing the process of manufacturing a semiconductor device according to a third embodiment of the present invention.

As shown in FIG. 4A, a P-type silicon substrate 20 is prepared as a semiconductor substrate. A silicon oxide film 21 having a thickness of about 200 nm is formed on the silicon substrate 20 using CVD process. A gate electrode polysilicon film 22 is formed on the silicon oxide film 21 to have a thickness of about 500 nm. A novolak film 23 having a thickness of about 300 nm is formed as a first layer on the polysilicon film 22 using spin coating. The novolak film 23 is used as an etching mask of the polysilicon film 22.

A positive DUV resist layer 24 having a thickness of about 100 nm is formed as photosensitive agent to KrF laser beam on the novolak film 23 using spin coating. The silicon substrate 20 formed with the resist layer 24 is baked; in this case, the baking temperature is 100 to 200° C., and the baking time is about one to two minutes.

The silicon substrate 20 coated with the resist layer 24 is set in an ArF excimer laser exposure system (aligner). For example, alignment of the silicon substrate 20 is carried out therein. Thereafter, an ArF laser beam passing through a photo mask is irradiated to the resist layer 24 on the silicon substrate 20 for a predetermined time. Then, the silicon substrate 10 is baked; in this case, the baking temperature is 100 to 200° C., and the baking time is about one to two minutes. As shown in FIG. 4B, the resist layer 24 is developed in order to form a first patterning layer 24a on the silicon substrate 10. In this case, the dimension of the first patterning layer 24a, for example, line and space width are both 0.11 μm.

As illustrated in FIG. 4C, the first patterning layer 24a is heated at the temperature from 100 to 200° C. for one to two minutes. The heat treatment is carried out, and thereby, the first patterning layer 24a is softened and fluidized. As a result, the dimension of the first patterning layer 24a is made large. By doing so, the space width of the first patterning layer 24a is slimmed down to 0.05 μm.

As depicted in FIG. 4D, a buried layer 25, that is, water-soluble silicone having a thickness of about 300 nm is formed on the first patterning layer 24a using spin coating. As seen from FIG. 4E, the buried layer 25 is etched back using dry etching. The buried layer 25 remains only in the recess between the first patterning layers 24a, and thereafter, is used as a second patterning layer 25a. As shown in FIG. 4F, the first patterning layer 24a is removed using a solvent. Thus, the second patterning layer 25a remains on the novolak film 23. According to another process, the first patterning layer 24a may be collectively removed in etching the novolak film 23.

The foregoing processes are carried out, and thereby, basic pattern formation is completed. Next, the pattern of the second patterning layer 25a is transferred to under-layer films. First, the novolak film 23 is etched using dry etching. As illustrated in FIG. 4G, the pattern of the second patterning layer 25a is transferred to the novolak film 23. Thereafter, the polysilicon film 22 is etched using dry etching. As seen from FIG. 4H, the pattern of the novolak film 23 is transferred to the polysilicon film 22. Thus, the polysilicon film 23 having small line width is formed.

In the third embodiment, the silicon oxide film on the silicon substrate is formed with the polysilicon film. In semiconductor devices such as LSIs, a gate oxide film is formed on the silicon substrate, and further, the polysilicon film is formed thereon as gate electrode. Of course, the present embodiment is applicable to the process described above.

According to the third embodiment, the pattern formed by photolithography technique is increased using a heat treatment, and in addition, the process of inverting pattern is carried out. By doing so, etching resistance is enhanced, and it is possible to form micro and high-accuracy patterns.

(Fourth Embodiment)

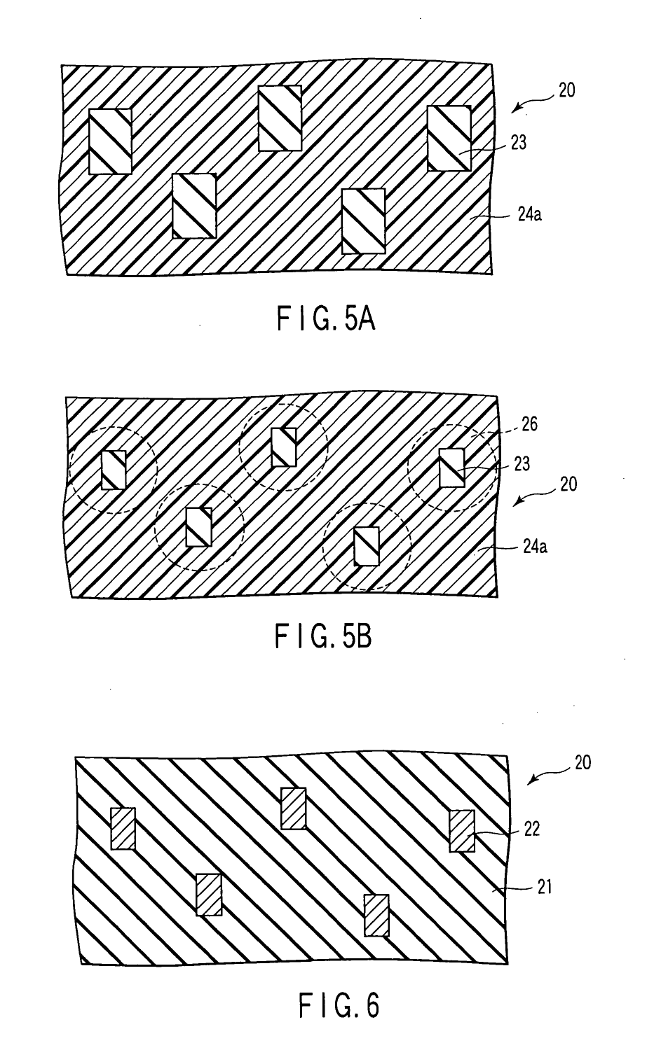

FIG. 5 and FIG. 6 are top plan views sequentially showing the process according to the second embodiment of the present invention.

In the third embodiment, relatively low-temperature heat treatment is carried out in order to make large the first patterning layer. In the fourth embodiment, an electron beam is used as the energy beam. According to the fourth embodiment, electron beam irradiation is carried out in place of heat treatment described in FIG. 4C of the third embodiment. Other processes are the same as the third embodiment; therefore, the detailed explanation is omitted.

The same process as FIG. 4A to FIG. 4B described in the third embodiment is carried out until a P-type silicon substrate 20 shown in FIG. 5A is prepared and pattern is made large. FIG. 5A is a top plan view showing the silicon substrate 20 in which the first patterning layer 24a is formed on the novolak film 23. As illustrated in FIG. 5B, an electron beam 26 shaped by an optical system (not shown) is irradiated to overlap with the exposed novolak film 23. The electron beam 26 is irradiated onto the silicon substrate at predetermined time intervals. In order to change regions to be heated,-the electron gun for generating the electron beam 26 and the silicon substrate 20 are moved relatively. The first patterning layer 24a of the electron beam irradiated region bulges due to being softened and fluidized. The first patterning layer 24a bulges, and thereby, the space width of the first patterning layer 24a is slimmed down to 0.06 μm.

The process after the first patterning layer 24a shown in FIG. 5B bulges is basically the same as the third embodiment. Here, silicon oxide film having a thickness of about 250 nm is formed as a buried film using spin coating. After the silicon oxide film is coated, the same processes as FIG. 4E to FIG. 4H are carried out. FIG. 6 shows the top surface of the silicon substrate 20 after the polysilicon film 22 formed on the silicon oxide film 21 is patterned. The polysilicon film 22 having a narrow line width is formed as in the third embodiment.

According to the fourth embodiment, the dimension of the pattern formed by photolithography is made large using energy beam irradiation, and further, the process of inverting the pattern is carried out. By doing so, etching resistance is improved, and it is possible to form micro and high-accuracy space patterns. According to the second embodiment, laser irradiation is possible with respect to only regions where a resist mask is formed, without irradiating electron beam to the entire surface of the silicon substrate. Therefore, manufacturing process efficiency is enhanced.

An laser beam or X-ray beam may be used as the energy beam, as well as an electron beam. Any of excimer laser, carbon dioxide laser, neodymium YAG laser may be used as the laser beam, in addition to an argon ion laser.

The present invention is not limited to the foregoing embodiments, and various modifications may be made within the scope without diverging from the inventive concept. For example, the present invention is applicable to any stages in pattern formation in the process of manufacturing semiconductor devices.

Slimming the patterning layer includes slimming the line pattern dimension. Enlarging the patterning layer includes thickening the line pattern dimension.

For example, thin films for forming patterns using inversion mask are not limited to Al and polysilicon, and are applicable to any of metal, semiconductor and insulating films used for semiconductor devices.

The present invention is a very effective technique for forming micro patterns exceeding the wavelength-limited resolution in photolithography technique. Of course, the present invention is applicable to the case where the micro-patterns do not exceed the limit of resolution.

Chemical treatments using ozone water, silane coupling agent and photo catalyst water require pattern slimming in particular. These chemical treatments may be employed as additional process to enhance the adhesion between substrate and buried film in the manufacture process requiring only surface treatment.

(Fifth Embodiment)

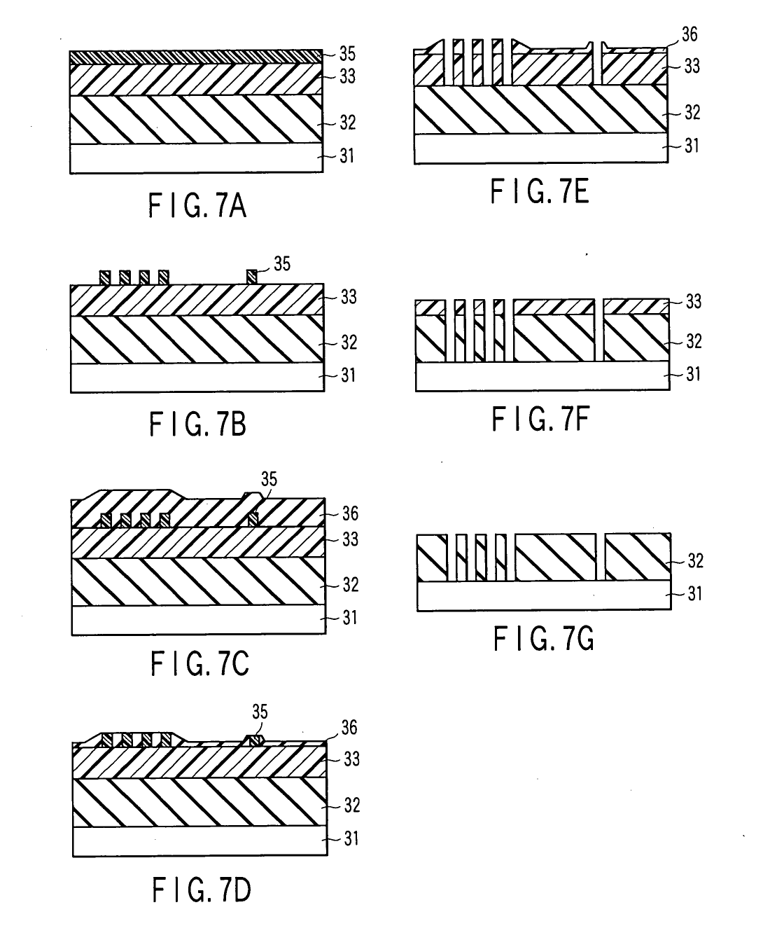

FIG. 7A to FIG. 7G is cross-sectional views showing the process of manufacturing a semiconductor device according to a fifth embodiment of the present invention.

As shown in FIG. 7A, a TEOS film 32 having a thickness of 500 nm is formed on a substrate 31. A polyacenaphthylene film 33 having a thickness of 500 nm is formed on the TEOS film 32. The polyacenaphthylene film 33 is formed in a manner of forming coating forming materials on the TEOS film 32 using spin coating, and baking them. A resist film 35 having a thickness of 125 nm is formed on the polyacenaphthylene film 33. The resist film 35 is formed in a manner of forming resist film forming materials on the polyacenaphthylene film 33 using spin coating, and baking them. The resist film 35 is chemically amplified ArF positive resist.

As illustrated in FIG. 7B, the resist film 35 is exposed using an ArF exposure system (aligner). Thereafter, PEB and development are carried out, and thereby, a resist pattern is obtained.

The pattern of the resist film 35 has one side length y (μm) of the maximum square region having 90% or more coverage and one side length x (μm) of the maximum square region having 10% or less coverage. The relation between side length y and x always satisfies the following equation (1).

y<84.29+44.63×10³×e^{-X}/17.80 (1)

The equation (1) is the requirement for the resist pattern described below. According to the requirement, the mask layer removal process made later is completed, and thereafter, a mask layer residual film exists at the entire removal region when the pattern of the resist film 35 is formed. In addition, no mask layer residual film exists at the entire residual region when the pattern of the resist film 35 is formed. The process of deriving the equation (1) will be explained later.

As depicted in FIG. 7C, a water-soluble silicone film 36 having a thickness of 500 nm is formed as a mask layer on the polyacenaphthylene film 33 using spin coating.

As seen from FIG. 7D, the water-soluble silicone film 36 is etched back by plasma of a CF₄/O₂ mixed gas. The residual film of the water-soluble silicone film 36 exists at the entire removal region when the pattern of the resist film 35 is formed. In addition, no residual film of the water-soluble silicone film 36 exists at the entire residual region when the pattern of the resist film 35 is formed. The water-soluble silicone film 36 existing at the removal region when the pattern of the resist film 35 is formed has the thickness described below. More specifically, the water-soluble silicone film 36 has a thickness always exceeding the minimum requirement 50 nm for etching the polyacenaphthylene film 33 having a thickness of 500 nm.

As shown in FIG. 7E, the resist film 35 and the polyacenaphthylene film 33 are etched by oxygen plasma using the water-soluble silicone film 36 as a mask. As illustrated in FIG. 7F, the TEOS film 32 is etched using the pattern of the polyacenaphthylene film 33 as a mask. As depicted in FIG. 7G, the polyacenaphthylene film 33 is subjected to ashing using oxygen plasma. The desired pattern of the TEOS film 32 is obtained via the processes described above.

The process of guiding the equation (1) will be explained below. The equation (1) expresses the following requirement for resist pattern:

“Mask layer removal process made later is completed, and thereafter, a mask layer residual film is formed so that it exists at the entire removed region when the pattern of the resist film 35 is formed. In addition, mask layer residual film is formed so that it does not exist at the entire remaining region when the pattern of the resist film 35 is formed (hereinafter, referred to as the entire surface being exposed).”

In the following description, the requirement is determined as 0. The requirement 0 is obtained based on the Document 1 relevant to the method of calculating a liquid level profile when coating liquid onto a stepped substrate using spin coating in the manner described later.

Document 1: P. y. Wu and F. C. Chou, J. Electrochem. Soc., 146, 3819 (1999)

When coating liquid onto the stepped substrate using spin coating, the liquid level profile is expressed by the following non-dimensional equation.

$$\frac{\partial H ( X , τ )}{\partial τ} = - \frac{1}{3} \frac{\partial }{\partial X} [ Ω - 2 ( \frac{{\partial }^{3} H ( X , τ )}{\partial {X}^{3}} + \frac{{\partial }^{3} S ( X )}{\partial {X}^{3}} ) {\{ H ( X , τ ) \}}^{3} + {\{ H ( X , τ ) \}}^{3} ]$$

$$where , \\ \begin{matrix}{Ω}^{2} ≡ \frac{ρ {ω}^{2} {w}^{3} {r}_{0}}{γ {h}_{f}} \\ X ≡ ( r - {r}_{0} / w ) \\ H ( X , τ ) ≡ h ( r , t ) / {h}_{f} \\ S ( X ) ≡ s ( r ) / {h}_{f} \\ τ ≡ \frac{4}{3} \frac{t}{\frac{w v}{{h}_{f}^{2} {ω}^{2} {r}_{0}}}\end{matrix}$$

The meanings of individual variables shown in the foregoing equation are as follows.

t: Time

r: Distance from the center of rotation

r₀: Central coordinate of target pattern (the center of rotation is the origin)

w: Width of target pattern

h (r, t): Thickness of coating material

h_{f}: Thickness of coating film on fully flat substrate when t=∞

η: Viscosity of solution

ρ: Density of solution

ν: Kinematic viscosity of solution (≡η/ρ)

s (r, t): Profile of substrate

ω: Angular velocity of wafer rotation

γ: Surface tension of solution

In this case, Ω² is given as noticeable variable. The variable 106² is a dominant parameter relevant to step coverage. The smaller the variable 102 ² is, the more improved the step coverage is. In other words, the liquid level of solution becomes flat; therefore, a desired state is obtained in the application of inversion mask process.

In order to expose the entire surface of the resist in the fifth embodiment, the requirement 2 for resist pattern must be satisfied. The requirement 2 is defined as follows. “The entire surface of the resist is exposed in the case where the etch-back depth margin becomes the largest when taking the ranges given below into consideration (case where the loosest limitation is given). The ranges are a thickness range of the resist film to be applied, mask layer thickness range, substance property range of etching mask material and process condition range.”

The following values are used as parameters when the process margin becomes highest.

r₀: 3.0 cm

h_{f}: 1.0 μm

ρ: 0.8 g/cm³

ω: 2π×1000 rad

γ: 60 dyn/cm

d: 0.3 μm (where, d is height of resist film)

In order to satisfy the foregoing requirement 2, the requirement 3 for the resist pattern must be satisfied. The requirement 3 is defined as follows. “The difference between surface heights of etching mask materials on the center at the widest resist remaining pattern portion and at the widest resist removed pattern portion is smaller than resist pattern height.”

In the fifth embodiment, “the widest resist remaining pattern portion” is defined as “the maximum square region having 90% or more coverage, selected from resist film pattern.” The reason is as follows. A pattern is formed such that micro slits and holes are periodically inserted in a wide residual pattern. It is proper that the pattern is regarded as substantially one large residual pattern in view of stepped substrate coating. Simulation was conducted; as a result, it was confirmed that the 90% level is suitable. Meanwhile, “the widest resist removed pattern portion” is defined as “the maximum square region having 10% or less coverage, selected from resist film pattern.” The reason is as follows. Pattern is formed such that micro lines and pillars are periodically inserted in wide residual pattern. It is proper that the pattern is regarded as substantially one large removal pattern in view of stepped substrate coating. Simulation was conducted; as a result, it was confirmed that the 10% level is suitable.

In order to satisfy the foregoing requirement 3, the requirement 4 for resist pattern must be satisfied. The requirement 4 is defined as follows. “The difference between surface heights of etching mask materials on the pattern center when no resist removed pattern exists around the widest resist remaining pattern portion and when no resist remaining pattern exists around the widest resist removed pattern portion is smaller than resist pattern height.”

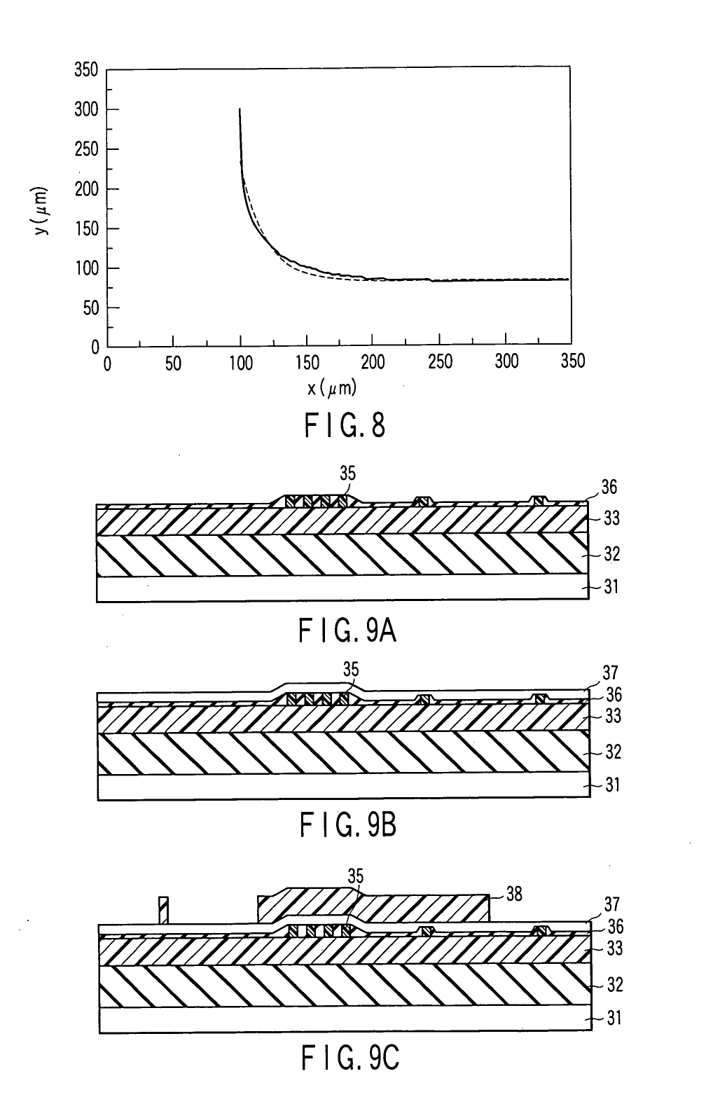

Here, one side length of “the maximum square region having 90% or more coverage, selected from resist film pattern” is set as yμm. One side length of “the maximum square region having 10% or less coverage, selected from resist film pattern” is set as xμm. By doing so, a set of y and x satisfy this requirement 4. When the set is expressed using approximate equation, the equation (1) described before is obtained. In FIG. 8, there are shown the boundary line (solid line) of the set and fitted curve (broken line). In this case, the boundary line is obtained by finding the set of y and x satisfying the requirement 4 using simulation.

Therefore, the resist film pattern needs to always satisfy the equation (1) to order to expose the entire surface of resist.

(Sixth Embodiment)

Element pattern is not formed even if only method described in the fifth embodiment is employed. In the sixth embodiment, the method of forming the element pattern will be explained below.

Pattern formations by lithography are carried out two times. In the first time, patterning is carried out to include a region satisfying the following requirement. That is, the relation between one side length y (μm) of the maximum square region having 90% or more pattern coverage of a resist film and one side length x (μm) of the maximum square region having 10% coverage or less always satisfies the equation (1).

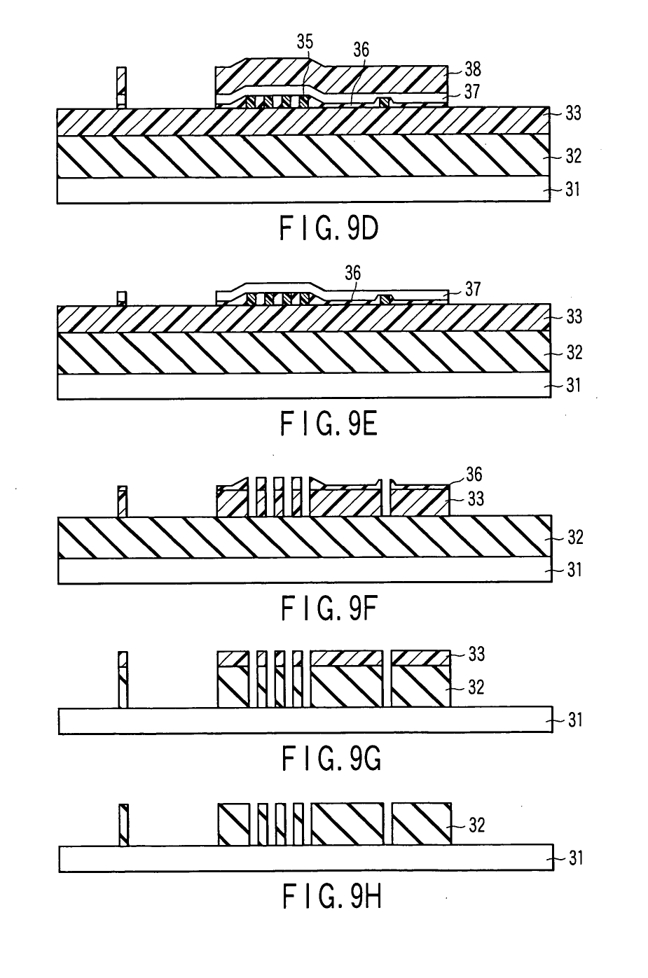

FIG. 9A to FIG. 9H are cross-sectional views showing the process of manufacturing a semiconductor device according to a sixth embodiment of the present invention.

As shown in FIG. 9A, the following films are successively formed on a substrate 31. The films are TEOS film 32 having a thickness of 500 nm, polyacenaphthylene film 33 having a thickness of 500 nm, first resist film 35 and water-soluble silicone film 36 having a thickness of 500 nm. The water-soluble silicone film 36 is etched back by plasma of CF₄/O₂ mixed gas. The residual film of the water-soluble silicone film 36 exists at the entire removed region when the pattern of the resist film 35 is formed. In addition, the residual film of the water-soluble silicone film 36 does not exist at the entire remaining region when the pattern of the resist film 35 is formed. The water-soluble silicone film 36 existing at the removal region when the pattern of the resist film 35 is formed has the thickness described below. More specifically, the water-soluble silicone film 36 has a thickness always exceeding the minimum requirement, that is, 50 nm for etching the polyacenaphthylene film 33 having a thickness of 500 nm. This process is the same as described in FIG. 7A to FIG. 7D of the fifth embodiment; therefore, the explanation is omitted. In the sixth embodiment, the pattern of the first resist film 35 satisfied the requirement like the fifth embodiment. That is, the relation between one side length y (μm) of the maximum square region having 90% or more coverage and one side length x (μm) of the maximum square region having 10% or less coverage satisfies the equation (1).

As illustrated in FIG. 9B, the substrate 31 is coated with a solution containing an anti-reflection material, and thereafter, is subjected to pre-baking to form a second anti-reflection film 37 having a thickness of 85 nm.

As depicted in FIG. 9C, a positive second resist film 38 having a thickness of 300 nm is formed on the second anti-reflection film 37. The second resist film 38 is formed by coating a resist agent on the anti-reflection film 37 using spin coating, and thereafter, pre-baking it. The second resist film 38 is a positive ArF resist. Further, the second resist film 38 is exposed and developed, and thereby, the pattern of the second resist film 38 is obtained. The pattern of the second resist film 38 forms an arbitrary pattern.

As seen from FIG. 9, the foregoing second anti-reflection film 37, water-soluble silicone film 36 and first resist film 35 are etched using the pattern of the second resist film 38 as a mask. As shown in FIG. 9E, a beam is irradiated to the entire surface of the second resist film 38 so that the second resist film 38 is developed. With this development, the second resist film 38 is removed.

As illustrated in FIG. 9F, the second anti-reflection film 37 and the first resist film 35 are removed by oxygen plasma irradiation. Oxygen plasma is further irradiated so that the polyacenaphthylene film 33 is patterned. Patterning of the polyacenaphthylene film 33 is carried out using the water-soluble silicone film 36 as a mask. Under the condition of using the oxygen plasma, it is general that the etching rate of the silicon atom containing material such as a water-soluble silicone film 36, is considerably slower than that of anti-reflection or resist film.

As depicted in FIG. 9G, the TEOS film 32 is etched using the pattern of the polyacenaphthylene film 33 as a mask. As seen from FIG. 9H, the polyacenaphthylene film 33 is removed by ashing using oxygen plasma. The processes described above are carried out, and thereby, the TEOS film 32 having a desired pattern is obtained.

Incidentally, the relation between one side length y (μm) of the maximum square region where the pattern of the first resist film 35 has 90% or more coverage and one side length x (μm) of the maximum square region where the same has 10% or less coverage has no need to always satisfy the equation (1). In this case, the pattern of the first resist film 35 is sufficient if only it always satisfies the equation (1) in the stacked region of the first and second resist films 35 fand 38. There remains the water-soluble silicone film 36 around the first resist film 35 in the region where the pattern coverage of the first resist film 35 does not satisfy the equation (1). However, the water-soluble silicone film 36 is removed in patterning the water-soluble silicone film 36 using the second resist film as a mask.

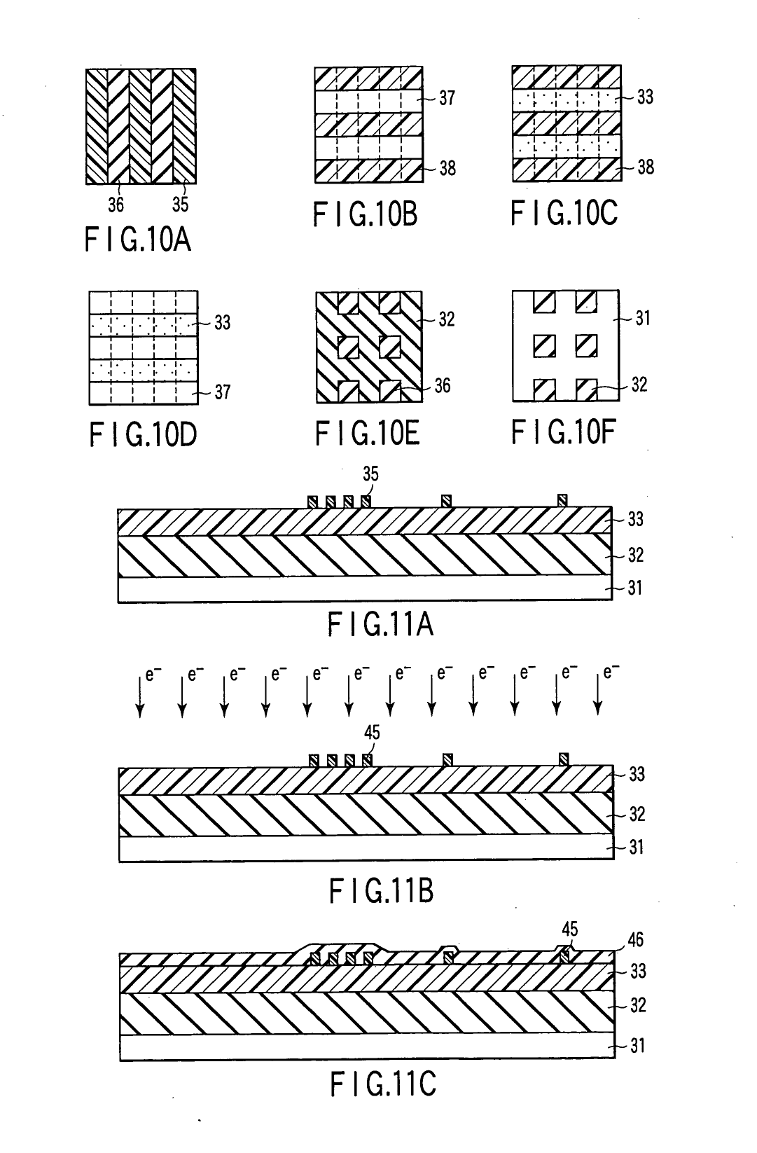

The patterns of the first and second resist films are combined, and thereby, it is possible to readily form a pattern, which is hard to be formed by normal lithography in view of the exposure margin. To give an example, the following case is considered. The first resist film include L/S pattern, and an L/S pattern crossing vertically to the LS pattern is stacked as a second resist film. The modification example of the process of manufacturing the semiconductor device according to the sixth embodiment of the present invention will be explained with reference to FIG. 10A to FIG. 10F. In the following, the explanation will be made correspondingly to FIG. 9A to FIG. 9H.

As shown in FIG. 10A, the pattern of the first resist film 35 including the L/S pattern is formed (corresponding to the process of FIG. 9A). The water-soluble silicone film 36 is deposited, and thereafter, the upper surface of the first resist film 35 is exposed. As illustrated in FIG. 10B, the second anti-reflection film 37 is formed. Thereafter, the second resist film 38 having an L/S pattern vertical to the L/S pattern of the first resist film is formed (corresponding to the process of FIG. 9C). As depicted in FIG. 10C, the second anti-reflection film 37 and the water-soluble silicone film 36 are etched using the second resist film 38 as a mask (corresponding to the process of FIG. 9D).- As seen from FIG. 10D, the second resist film 38 is removed (corresponding to the process of FIG. 9E). As shown in FIG. 10E, oxygen plasma is irradiated to remove the second anti-reflection film 37 and the first resist film 35 (corresponding to the process of FIG. 9F). As illustrated in FIG. 10F, the TEOS film 32 is etched using a water-soluble silicone film 36 and polyacenaphthylene film 33 as a mask (corresponding to the process of FIG. 9G). Thereafter, the water-soluble silicone film 36 and the polyacenaphthylene film 33 are removed (corresponding to the process of FIG. 9H).

As seen from the processes described above, two resist films are combined, and thereby, a nested pillar pattern having a small exposure margin is formed.

(Seventh Embodiment)

The seventh embodiment is basically the same process as the sixth embodiment. In the seventh embodiment, the treatment for providing a solvent resistance to the pattern of the first resist film is carried out.

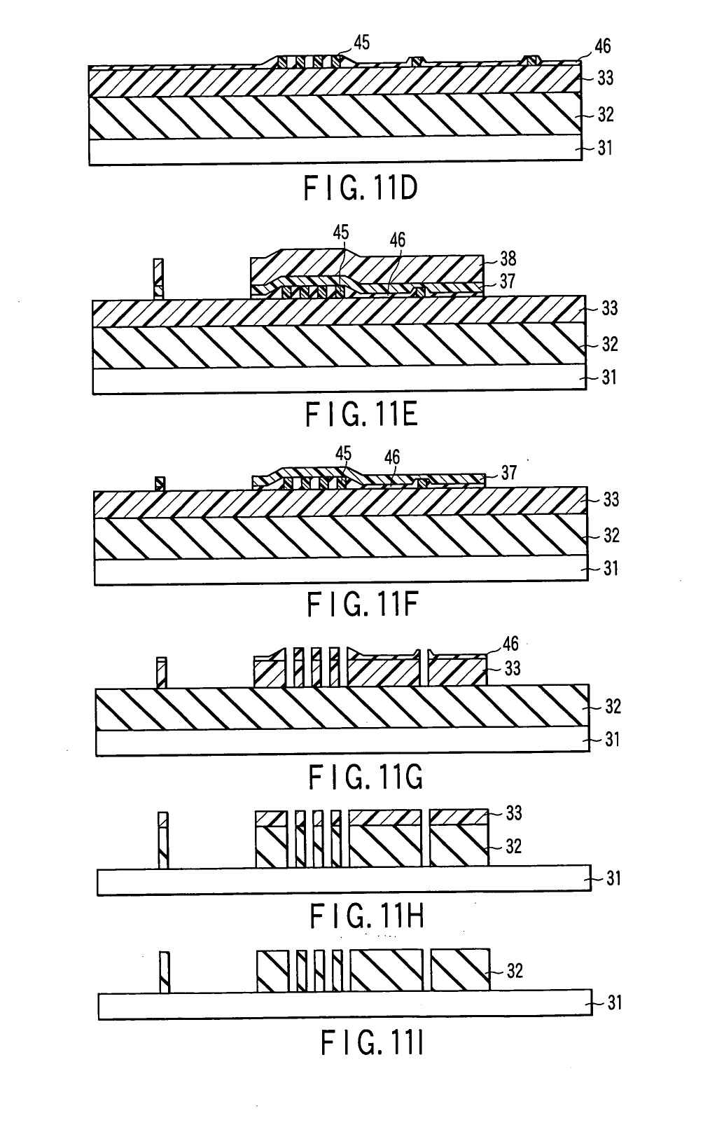

FIG. 11A to FIG. 11I are cross-sectional views showing the process of manufacturing a semiconductor device according to a seventh embodiment of the present invention.

As shown in FIG. 11A the following films are successively formed on a substrate, like the sixth embodiment. The films are a TEOS film 32 having a thickness of 500 nm, polyacenaphthylene film 33 having a thickness of 500 nm, first resist film 35 and water-soluble silicone film 36 having a thickness of 500 nm.

As illustrated in FIG. 11B, an electron beam is irradiated to the resist film 35 to carry out EB curing, thereby obtaining a modified resist film 45. The modified resist film 45 has resistance to organic solvents.

As depicted in FIG. 11C, an SOG film (mask layer) 46 having a thickness of 500 nm is formed on the entire surface using spin coating. The solution of the SOG film contains an organic solvent. If the solution of the SOG film containing an organic solvent is coated to the first resist film 35 before being modified, the pattern of the first resist film 35 is broken. However, in the seventh embodiment, the solution of the SOG film is coated to the resist film 45 modified by EB curing. Therefore, it is possible to prevent the pattern of the first resist film 35 from being broken.

As seen from FIG. 1D, the SOG film 46 is etched back the by plasma of CF₄/O₂ mixed gas. A residual SOG film 46 exists over the entire removed region when the pattern of the first resist film 35 is formed. In addition, a residual SOG film 46 does not exist over the entire remaining region when the pattern of the first resist film 35 is formed. The SOG film 46 existing at the removal region when the pattern of the first resist film 35 is formed has the thickness described below. More specifically, the SOG film 46 has a thickness always exceeding the minimum requirement, that is, 50 nm for etching the polyacenaphthylene film 33 having a thickness of 500 nm.

As shown in FIG. 11E, the second anti-reflection film 37 has a thickness of 85 nm and the pattern of the second resist film 38. The second resist film 38 is a positive ArF resist. Then, the second anti-reflection film 37 and the SOG film 46 are etched using the pattern of the second resist film 38 as a mask.

As illustrated in FIG. 11F, a beam is irradiated onto the entire surface of the wafer so that the second resist film 38 is developed and removed.

As depicted in FIG. 11G, the second anti-reflection film 37 is removed using oxygen plasma while the polyacenaphthylene film 33 is patterned. Under the condition using the oxygen plasma, it is general that the etching rate of the silicon atom containing material such as water-soluble silicone film 36 is considerably slower than that of anti-reflection or SOG film.

As seen from FIG. 11H, the TEOS film 32 is etched using the pattern of the polyacenaphthylene film 33 as a mask. As shown in FIG. 11I, the polyacenaphthylene film 33 is removed by ashing using oxygen plasma, and thereby, the TEOS film 32 having a desired pattern is obtained.

Incidentally, the relation between one side length y (μm) of the maximum square region where the pattern of the first resist film 35 has 90% or more coverage and one side length x (μm) of the maximum square region where the same has 10% or less coverage has no need to always satisfy the equation (1). In this case, the pattern of the first resist film 35 is sufficient if only it always satisfies the equation (1) in the stacked region of the first and second resist films 35 and 38. There remains the SOG film 46 around the first resist film 35 in the region where the pattern coverage of the first resist film 35 does not satisfy the equation (1). However, the SOG film 46 is removed in patterning the SOG film 46 using the second resist film as a mask.

According to the seventh embodiment, it is possible to use materials such that their resist pattern is usually broken if organic solvent used as the mask layer solvent is intactly coated onto its first resist pattern.

In the embodiment, electron beam irradiation is employed as the treatment for providing solvent resistance. The present invention is not limited to the seventh embodiment. For example, light beam, ion and radical irradiations may be used.

In the embodiment, the SOG film is used as the mask layer. The present invention is not limited to the seventh embodiment. Materials having an etching resistance to an under-layer film are usable; for example, various silicon atom containing materials and metal containing materials may be used.

(Eighth Embodiment)

The eighth embodiment is basically the same process as the sixth embodiment. In the eighth embodiment, a first anti-reflection film is formed under the first resist film.

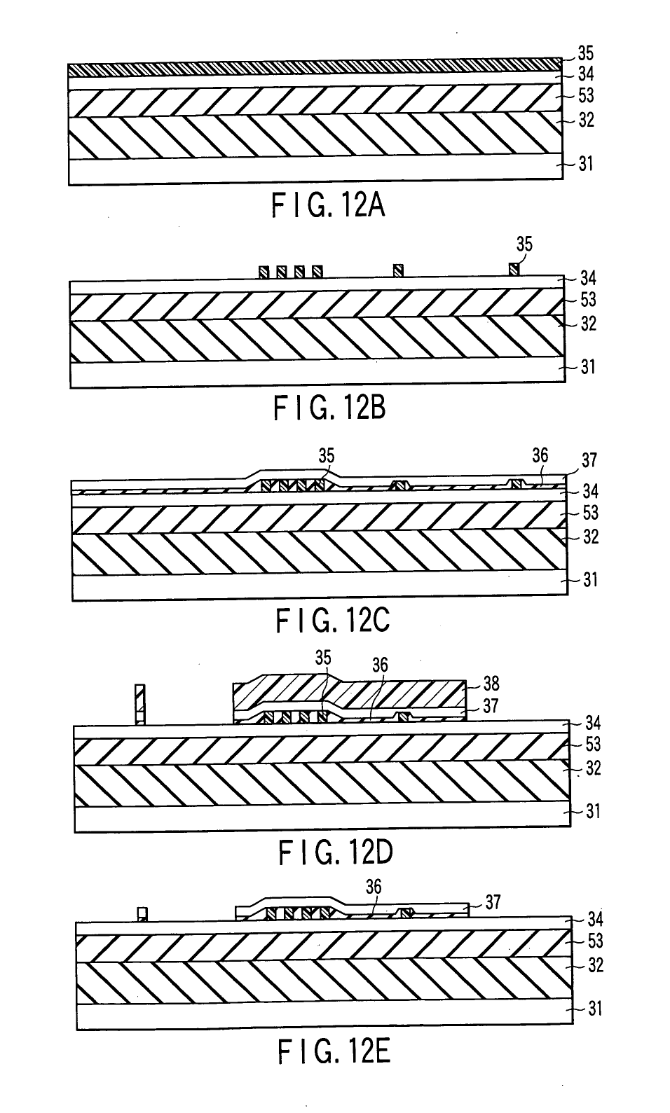

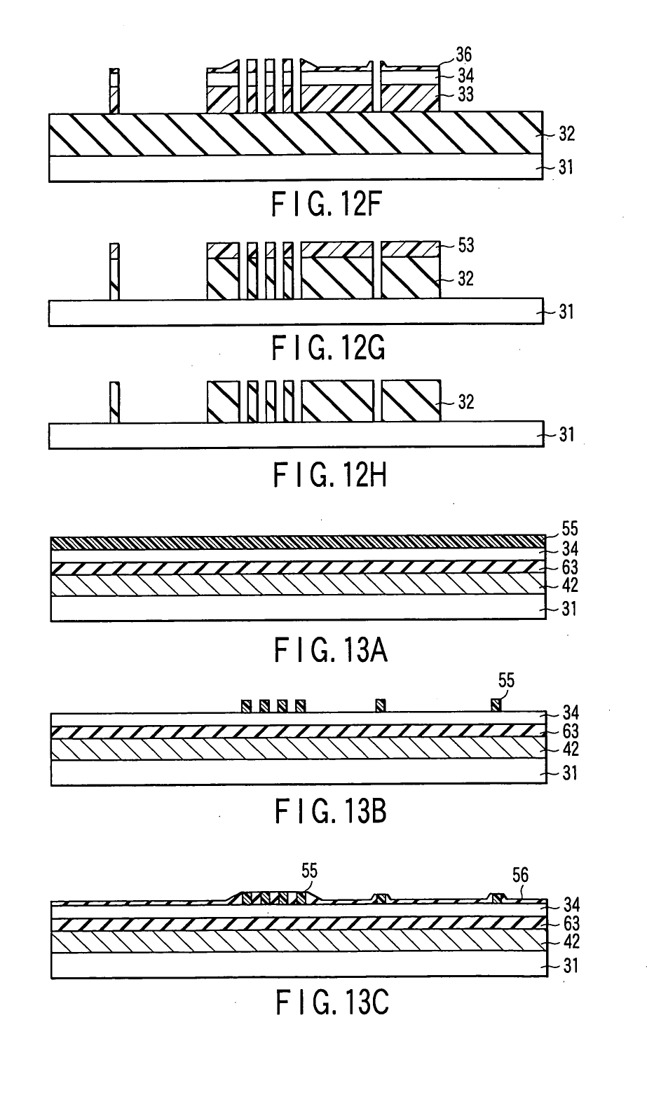

FIG. 12A to FIG. 12H are cross-sectional views showing the process of manufacturing a semiconductor device according to an eighth embodiment of the present invention.

As shown in FIG. 12A, a TEOS film (first film) 32 having a thickness of 500 nm is formed on a substrate 31. Thereafter, a carbon film 53 having a thickness of 300 nm is formed on the TEOS film 32 as an under-layer film using sputtering. A first anti-reflection film 34 having a thickness of 85 nm is formed on the carbon film 53. A first resist film 35 is formed on the first anti-reflection film 34.

As illustrated in FIG. 12B, the first resist film 35 is exposed using an ArF exposure system, and thereafter, PEB and development are carried out, and thereby, the pattern of the first resist film 35 is obtained.

The pattern of the first resist film 35 has a region satisfying the requirement described below. That is, the relation between one side length y (μm) of the maximum square region having 90% or more coverage and one side length x (pin) of the maximum square region having 10% or less coverage satisfies the equation (1).

As depicted in FIG. 12C, a water-soluble silicone film 36 having a thickness of 500 nm is formed using spin coating, and thereafter, is etched back by the plasma of CF₄/O₂ mixed gas. A second anti-reflection film 37 having a thickness of 85 nm is formed on the water-soluble silicone film 36.

As, seen from FIG. 12D, a positive ArF resist having a thickness of 300 nm is formed as a second resist film 38. The second resist film 38 is exposed and developed so that a pattern of the second resist film 38 is obtained. The second anti-reflection film 37 and the water-soluble silicone film 36 are etched using that pattern of the second resist film 38 as a mask. As shown in FIG. 12E, a beam is irradiated onto the entire surface of wafer so that the second resist film 38 is developed and removed.

As illustrated in FIG. 12F, the second anti-reflection film 37 is removed using oxygen plasma so that the carbon film 53 is patterned. Under the condition using the oxygen plasma, it is general that the etching rate of silicon atom containing material such as water-soluble silicone film is considerably slower than that of the anti-reflection or carbon film.

As depicted in FIG. 12G, the TEOS film 32 is etched using the carbon film 53 as a mask. As seen from FIG. 12H, the pattern of the carbon film 53 is subjected to ashing using oxygen plasma, and thereby, a desired pattern of the TEOS film 32 is obtained.

Incidentally, the relation between one side length y (μm) of the maximum square region where the pattern of the first resist film 35 has 90% or more coverage and one side length x (μm) of the maximum square region where the same has 10% or less coverage has no need to always satisfy the equation (1). In this case, the pattern of the first resist film 35 is sufficient if only it always satisfies the equation (1) in the stacked region of the first and second resist films 35 and 38. There remains the water-soluble silicone film 36 around the first resist film 35 in the region where the pattern coverage of the first resist film 35 does not satisfy the equation (1). However, the water-soluble silicone film 36 is removed in patterning the water-soluble silicone film 36 using the second resist film as a mask.

According to the eighth embodiment, it is possible to carry out patterning of the first resist film 35 with high accuracy even if the under-layer film has high reflectivity.

In the eighth embodiment, the carbon film formed by sputtering is used as the under-layer film. The present invention is not limited to the formation process and kind of under-layer film described in the eighth embodiment. For example, a carbon film formed by CVD may be used. Of course, the under-layer film described in the fifth embodiment is usable.

(Ninth Embodiment)

The ninth embodiment is basically the same process as the second embodiment. In the ninth embodiment, a first anti-reflection film is formed under the first resist film.

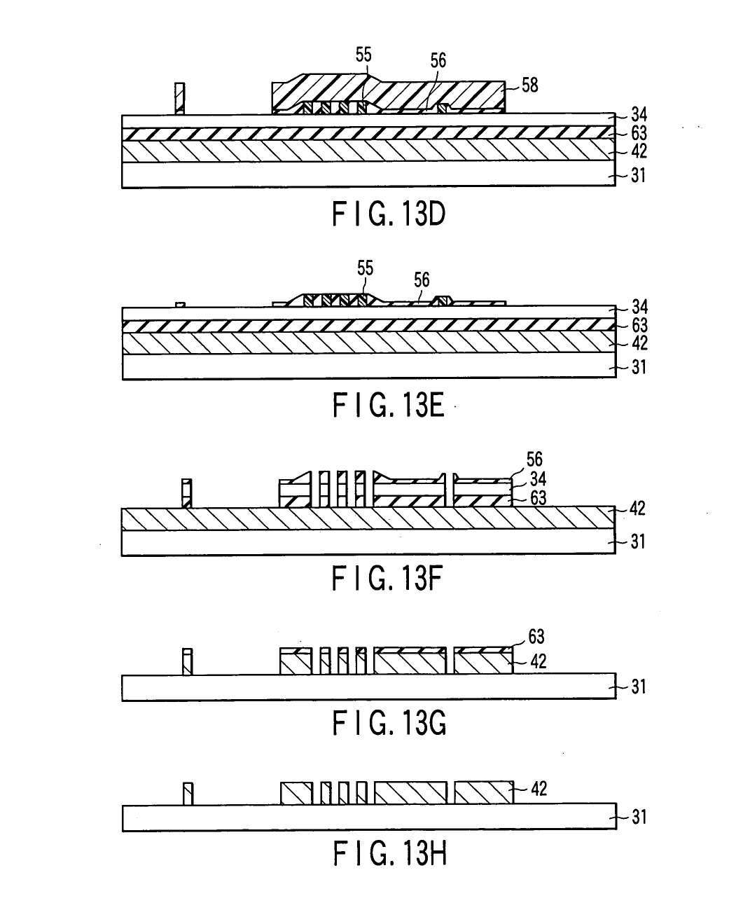

FIG. 13A to FIG. 13H are cross-sectional views showing the process of manufacturing a semiconductor device according to a ninth embodiment of the present invention.

As shown in FIG. 13A, an Al film (first film) 42 having a thickness of 250 nm is formed on a substrate 31. Thereafter, a silicon nitride film 63 having a thickness of 100 nm is formed as an under-layer film on the Al film 42 using sputtering. A first anti-reflection film 34 having a thickness of 85 nm is formed on the silicon nitride film 63. A first resist film 55 is formed on the first anti-reflection film 34 using coating. In the ninth embodiment, the first resist film 55 is a Si containing resist.

As illustrated in FIG. 13B, the first resist film 55 is exposed using an ArF exposure system, and thereafter, PEB and development are carried out, and thereby, the pattern of the first resist film 55 is obtained.

The pattern of the first resist film 35 has a region satisfying the requirement described below. That is, the relation between one side length y (μm) of the maximum square region having 90% or more coverage and one side length x (μm) of the maximum square region having 10% or less coverage satisfies the equation (1). An electron beam is irradiated onto the first resist film 55 to carry out EB curing, and thereby, a modified first resist film 55 is obtained. The modified first resist film 55 has a resistance to organic solvent.

As depicted in FIG. 13C, a polyacenaphthylene film 57 having a thickness of 500 nm is formed using spin coating, and thereafter, is etched back by oxygen plasma.

As seen from FIG. 13D, a positive Si containing resist is formed as a second resist film 58. The second resist film 58 is exposed and developed to obtain the pattern of the second resist film 58. The polyacenaphthylene film 57 is etched using that pattern of the second resist film 58 as a mask. As shown in FIG. 13E, a beam is irradiated onto the entire surface of the wafer so that the second resist film 58 is developed and removed.

As illustrated in FIG. 13F, a fluorocarbon gas plasma is supplied so that the first resist film 55 is removed while the polyacenaphthylene film 57 is patterned. As seen from FIG. 13G, Cl₂ and BCl₃ plasmas are supplied to etch the Al film 42 using the silicon nitride film 63. As shown in FIG. 13H, the pattern of the silicon nitride film 63 is subjected to ashing using oxygen plasma, and thereby, a desired pattern of the Al film 42 is obtained.

Incidentally, the region having the requirement described below may be given. That is, the relation between one side length y (μm) of the maximum square region where the pattern of the first resist film 55 has 90% or more coverage and one side length x (μm) of the maximum square region where the same has 10% or less coverage does not satisfy the equation (1). In this case, the pattern of the first resist film 55 is sufficient if only it always satisfies the equation (1) in the stacked region of the first and second resist films 55 and 58. There remains the polyacenaphthylene film 57 around the first resist film 55 in the region where the pattern of the first resist film 55 does not satisfy the equation (1). However, the polyacenaphthylene film 57 is removed in patterning the polyacenaphthylene film 57 using the second resist film 58 as a mask.

According to the ninth embodiment, it is possible to carry out patterning of the first resist film 55 even if the under-layer film has high reflectivity.

In the ninth embodiment, the silicon nitride film is used as the under-layer film. The present invention is not limited to the formation process and kind of the under-layer film described in the eighth embodiment. For example, an SiO₂ film and amorphous silicon may be used. Of course, the under-layer film described in the fifth embodiment is also usable.

In the ninth embodiment, the polyacenaphthylene film is used as the mask layer. The present invention is not limited to this embodiment, and materials having an etching resistance to the under-layer film are usable. For example, a novolak resin film, polyimide film polyallylene film and polyallylene ether film may be used.

(Tenth Embodiment)

The tenth embodiment is basically the same process as the eighth embodiment. In the tenth embodiment, the method of forming films without using under-layer film.

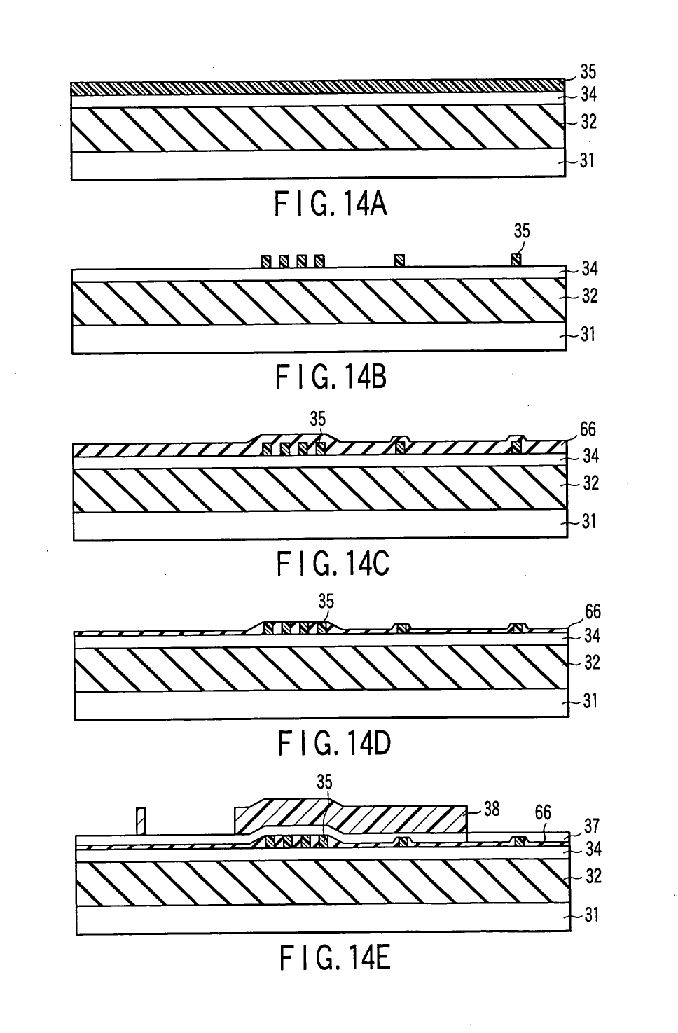

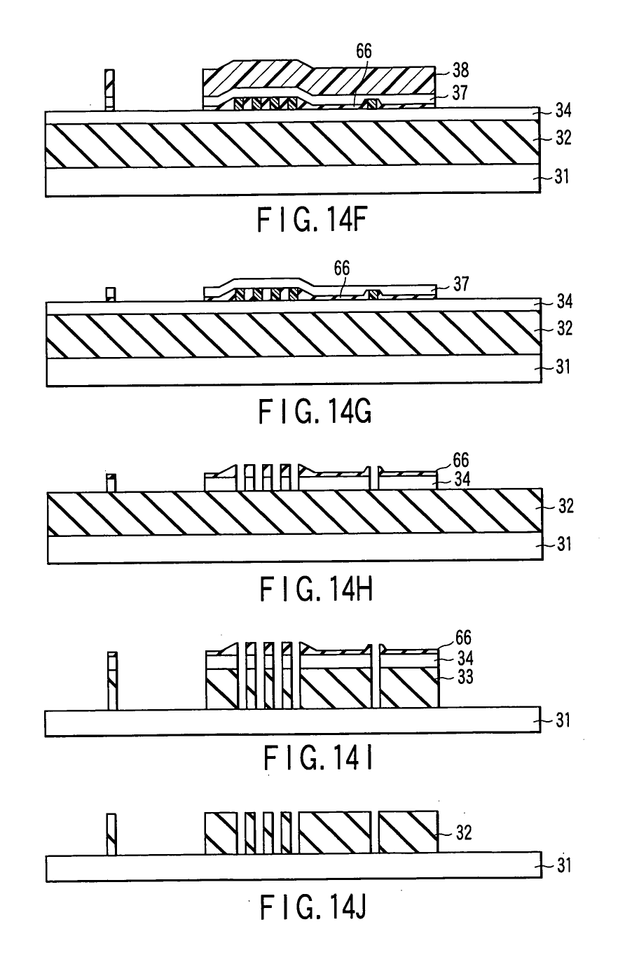

FIG. 14A to FIG. 14J are cross-sectional views showing the process of manufacturing a semiconductor device according to a tenth embodiment of the present invention.

As shown in FIG. 14A, the following films are formed on a substrate 31. The films are TEOS film 32 having a thickness of 500 nm, first anti-reflection film having a thickness of 85 nm and first resist film having a thickness of 125 nm.

As illustrated in FIG. 14B, the first resist film 35 is exposed using an ArF exposure system, and thereafter, PEB and development are carried out, and thereby, the pattern of the first resist film 35 is obtained. An electron beam is irradiated to the pattern of the first resist film 35 to obtain a modified first resist film 45.

The pattern of the first resist film 35 has a region satisfying the requirement described below. That is, the relation between one side length y (μm) of the maximum square region having 90% or more coverage and one side length x (μm) of the maximum square region having 10% or less coverage always satisfies the equation (1).

As depicted in FIG. 14C, titania (titanium oxide) film 66 is formed on the entire surface to have a thickness of 500 nm. The titania film is formed using a sol-gel process.

As seen from FIG. 14D, the titania film 66 is etched back by plasma of Cl gas. The residual film of the titania film 66 exists over the entire removed region when the pattern of the first resist film 45 is formed. In addition, the residual film of the titania film 66 does not exist over the entire remaining region when the pattern of the first resist film 45 is formed. The titania film 66 existing over the removal region when the pattern of the first resist film 45 is formed has the thickness described below. More specifically, the titania film 66 has a thickness always exceeding the minimum requirement, that is, 50 nm for etching the polyacenaphthylene film 33 having a thickness of 500 nm.

As shown in FIG. 14E, a second anti-reflection film 37 having a thickness of 85 nm is formed. A second resist film 38 having a thickness of 300 nm is formed on the second anti-reflection film 37. The second resist film is a positive ArF resist. The second resist film 38 is exposed and developed so that pattern of the second resist film 38 is obtained.

As illustrated in FIG. 14F, the second anti-reflection film 37 and the titania 66 are etched using that pattern of the second resist film 38 as a mask. As depicted in FIG. 14G, a beam is irradiated onto the entire surface of wafer so that the second resist film 38 is developed and removed.

As seen from FIG. 14H, the second anti-reflection film 37 is removed using oxygen plasma, and thereafter, the first anti-reflection film 34 is patterned. Under the condition using the oxygen plasma, it is general that the etching rate of the titania film 66 is considerably slower than that of the anti-reflection or carbon film.

As shown in FIG. 14I, the TEOS film 32 is etched using the titania film 66. As illustrated in FIG. 14J, the titania film 66 and the first anti-reflection film 34 are removed by the plasma of Cl gas.

As described in the tenth embodiment, there is no need to use the under-layer film if it is possible to directly etch films using a mask layer pattern.

In the tenth embodiment, the first anti-reflection film is formed; however, the formation of the first anti-reflection film may be omitted depending on the process of forming the first resist pattern. For example, the anti-reflection film is not always required if the first resist pattern is formed using an electron beam.

In the tenth embodiment, the titania film is used as the mask layer. The present invention is not limited to this embodiment. Any other materials may be used so long as they have etching resistance to film. For example, various silicon atom containing materials and metal atom containing materials may be used. In addition, if the etching mask is formed of a material that does not break the first resist pattern, it is possible to omit the process of providing a resistance to a solvent.

Incidentally, the pattern of the first resist film 35 has no need to always satisfy the equation (1). In this case, the pattern of the first resist film 35 is sufficient if only it always satisfies the equation (1) in the stacked region of the first and second resist films 35 and 38. There remains the titania film 66 around the first resist film 35 in the region where the pattern coverage of the first resist film 35 does not satisfy the equation (1). However, the titania film 66 is removed in patterning the titania film 66 using the second resist film as a mask.

(11-th Embodiment)

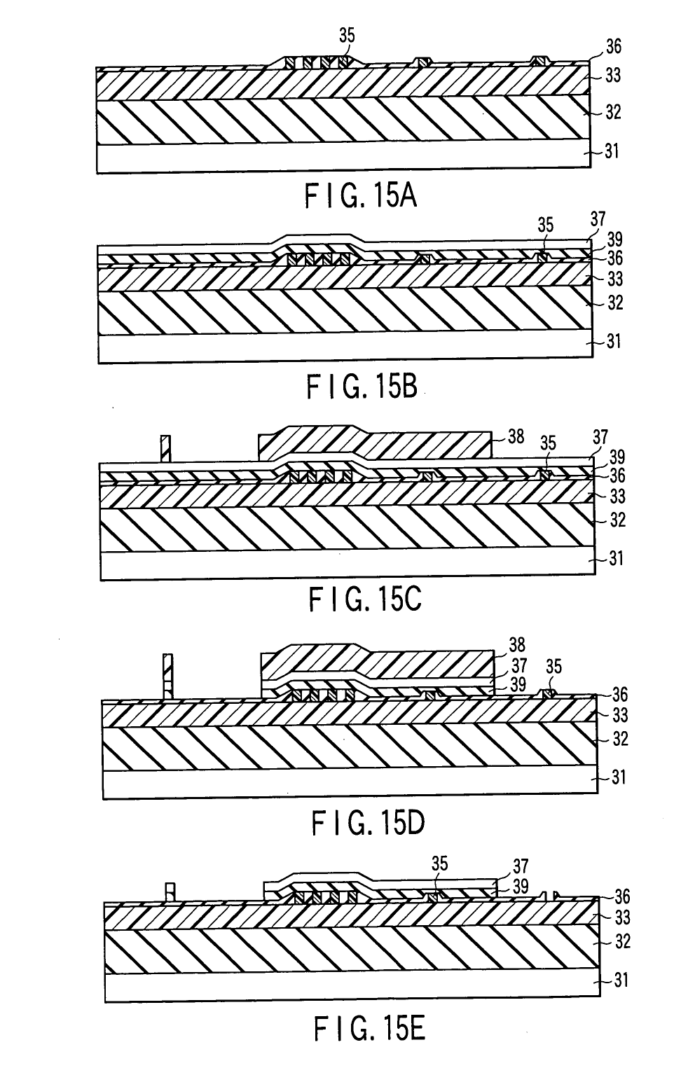

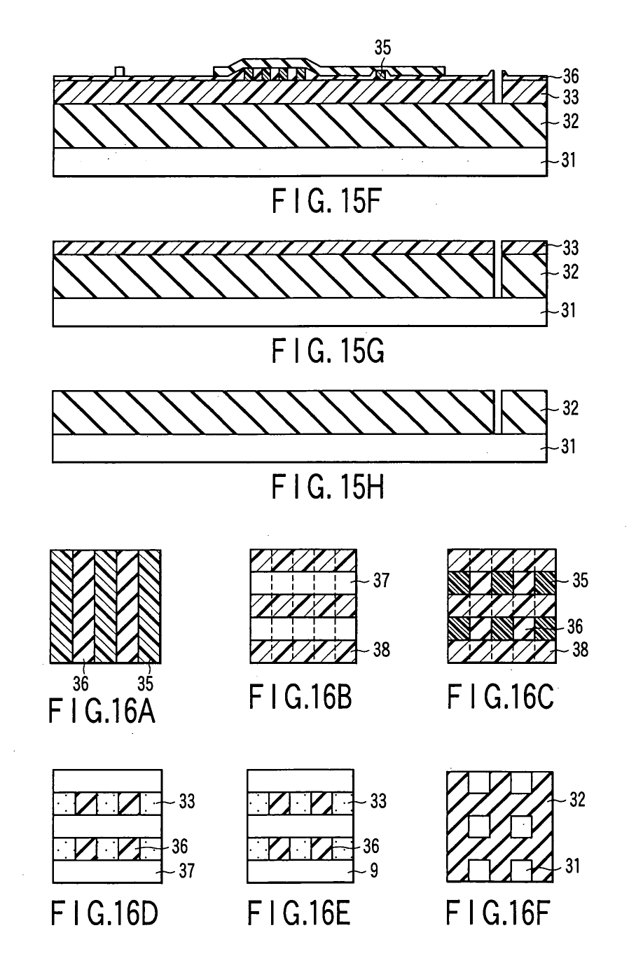

FIG. 15A to FIG. 15H are cross-sectional views showing the process of manufacturing a semiconductor device according to an 11-th embodiment of the present invention.

As shown in FIG. 15A, the following films are successively formed on a substrate. The films are TEOS film 32 having a thickness of 500 nm, polyacenaphthylene film 33 having a thickness of 500 nm, first resist film 35 and water-soluble silicone film 36 having a thickness of 500 nm. The foregoing process is the same as described in FIG. 7A to FIG. 7D of the fifth embodiment; therefore, the explanation is omitted. As illustrated in FIG. 15B, SOG film 39 having a thickness of 100 nm and second anti-reflection film 37 having a thickness of 85 nm are successively formed.

As depicted in FIG. 15C, the second anti-reflection film 37 is coated with a resist agent using spin coating, and thereafter, pre-baked to form a positive second resist film 38 having a thickness of 300 nm. The second resist film 38 is a positive ArF resist. The second resist film 38 is exposed and developed, and thereby, the pattern of the second resist film 38 is obtained.

As seen from FIG. 15D, the second anti-reflection film 37 is etched using the pattern of the second resist film 38 as a mask. As shown in FIG. 15E, a beam is irradiated to the entire surface of the wafer to develop the second resist film 38 and the exposed first resist film 35.

As shown in FIG. 15F, the polyacenaphthylene film 33 is patterned using oxygen plasma. In patterning, an SOG film and water-soluble silicone film are used as the mask. Even if the anti-reflection film is totally removed in patterning, the SOG film 39 exists in the under layer; therefore, the first resist under the SOG film 39 is not removed.

As illustrated in FIG. 15G, the foregoing anti-reflection film, first resist film and water-soluble silicone film are removed. The ETOS film 32 is etched using the polyacenaphthylene film 33 as a mask. As depicted in FIG. 15H, the polyacenaphthylene film 33 is subjected to ashing using oxygen plasma, and thereby, a desired pattern of the TEOS film 32 is obtained.

In the 11-th embodiment, the SOG film is used as the under-layer film. If the under-layer film is not used, any other film may be used as long as they have etching resistance to film. In the 11-th embodiment, materials containing one or more elements selected from silica and metal elements may be used.

The patterns of the first and second resist films are combined, and thereby, it is possible to readily form a pattern which is hard to be formed by normal lithography in view of exposure margin. To give an example, the following case is considered. The first resist film includes an L/S pattern, and an L/S pattern crossing vertically to the LS pattern is stacked as a second resist film. The modification example of the process of manufacturing the semiconductor device according to the 11-th embodiment of the present invention will be explained with reference to FIG. 16A to FIG. 16F. In the following, the explanation will be made correspondingly to FIG. 15A to FIG. 15H.

As shown in FIG. 16A, the pattern of the first resist film 35 including L/S pattern is formed (corresponding to the process of FIG. 15A). The water-soluble silicone film 36 is deposited, and thereafter, the upper surface of the first resist film 35 is exposed. As illustrated in FIG. 16B, the SOG film 39 and the second anti-reflection film 37 are formed. Thereafter, the second resist film 38 is formed to have L/S pattern vertical to the L/S pattern of the first resist film (corresponding to the process of FIG. 15B and FIG. 16C). As depicted in FIG. 16C, the second anti-reflection film 37 and the SOG film 39 are etched using the second resist film 38 as a mask (corresponding to the process of FIG. 15D). As seen from FIG. 16D, the second resist film 38 is removed (corresponding to the process of FIG. 15E). As shown in FIG. 16E, oxygen plasma is irradiated to remove the first resist film 35 in the region which is not coated with the second anti-reflection film 37 or SOG film 39 (corresponding to the process of FIG. 15F). As illustrated in FIG. 16F, the TEOS film 32 is etched using the SOG film 39 and the polyacenaphthylene film 33 as a mask (corresponding to the process of FIG. 15G). Thereafter, the water-soluble silicone film 36 and the polyacenaphthylene film 33 are removed (corresponding to the process of FIG. 15H). As seen from the processes described above, a nested hole pattern having a small exposure margin is formed.

(12-th Embodiment)

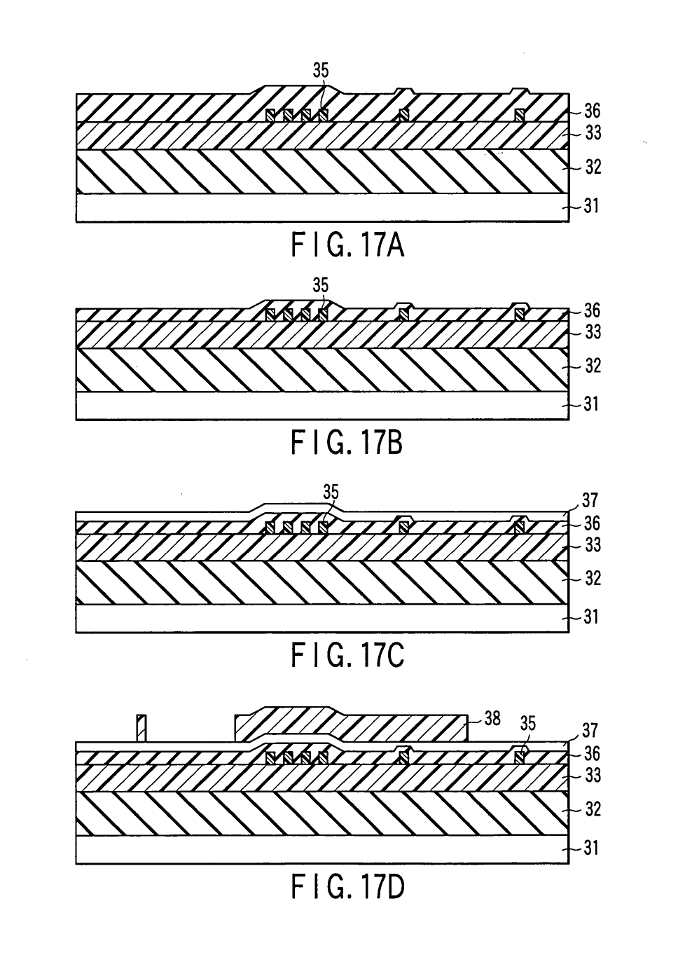

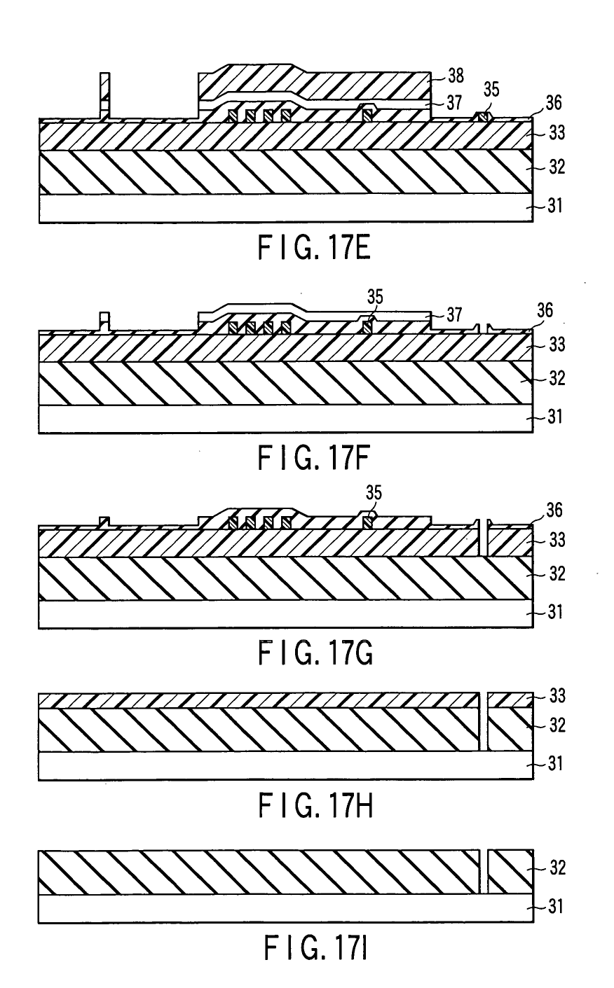

FIG. 17A to FIG. 17I are cross-sectional views showing the process of manufacturing a semiconductor device according to a 12-th embodiment of the present invention.

As shown in FIG. 17A, the following films are successively formed on a substrate. The films are TEOS film 32 having a thickness of 500 nm, polyacenaphthylene film 33 having a thickness of 500 nm, first resist film 35 and water-soluble silicone film 36 having a thickness of 500 nm. The foregoing process is the same as described in FIG. 7A and FIG. 7B of the fifth embodiment; therefore, the explanation is omitted.

As illustrated in FIG. 17B, the water-soluble silicone film 36 is etched back using plasma of CF₄/O₂ mixed gas. The etch-back depth is about 100 nm shallower than the case of the fifth embodiment. In this case, when the water-soluble silicone film 36 is deposited, the thickness is set to about 200 nm, and thereby, the structure shown in FIG. 17B is obtained.

As depicted in FIG. 17C, the second anti-reflection film 37 is coated to have a thickness of 85 nm, and thereafter, pre-baked. By doing so, the structure of FIG. 17C is substantially the same as that in FIG. 15B of the 11-th embodiment. As seen from FIG. 17D, a positive ArF resist is formed as the second resist film 38 using spin coating to have a thickness of 300 nm, and thereafter, pre-baked. The second resist film 38 is exposed and developed, and thereby, the pattern of the second resist film 38 is obtained.

As shown in FIG. 17E, the second anti-reflection film 37 and the water-soluble silicone film 36 are etched using the pattern of the second resist film 38 as a mask. The etching depth is set to satisfy the following requirement. More specifically, in the first and second resist film removed region, the water-soluble silicone film 36 has a thickness always exceeding the minimum requirement, that is, 50 nm for etching the polyacenaphthylene film 33 having a thickness of 500 nm.

As illustrated in FIG. 17F, a beam is irradiated onto the entire surface of wafer to develop the second resist film 38 and the exposed first resist film 35. As depicted in FIG. 17G, the second anti-reflection film 37 is removed using oxygen plasma, and thereafter, the polyacenaphthylene film 33 is patterned.

As seen from FIG. 17H, the ETOS film 32 is etched using the pattern of the polyacenaphthylene film 33 as a mask. As shown in FIG. 17H, the polyacenaphthylene film 33 is subjected to ashing using oxygen plasma, and thereby, a desired pattern of the TEOS film 32 is obtained.

(13-th Embodiment)

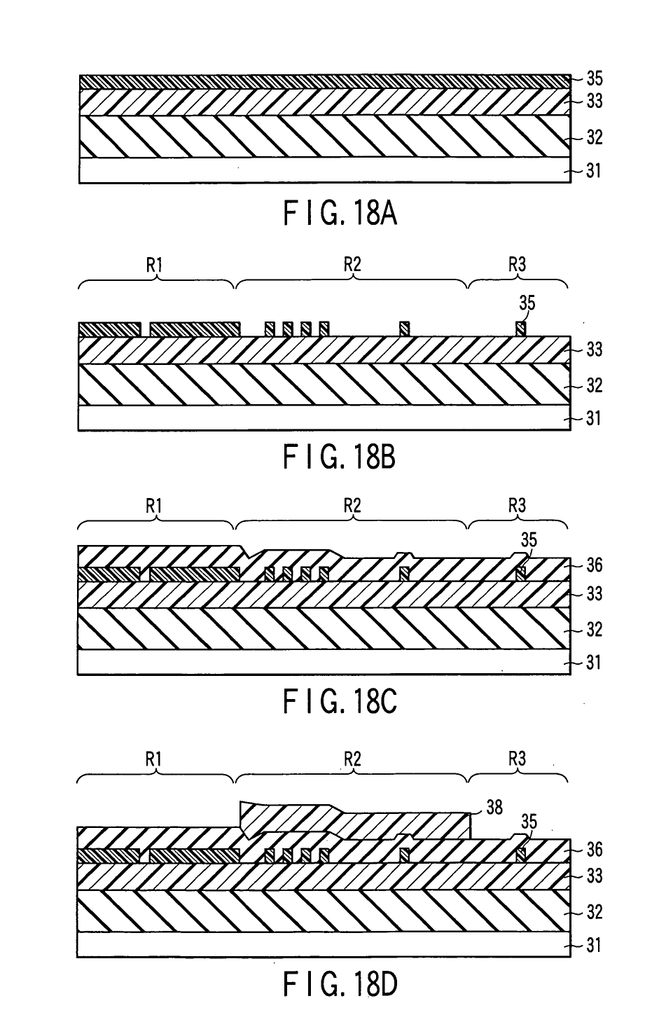

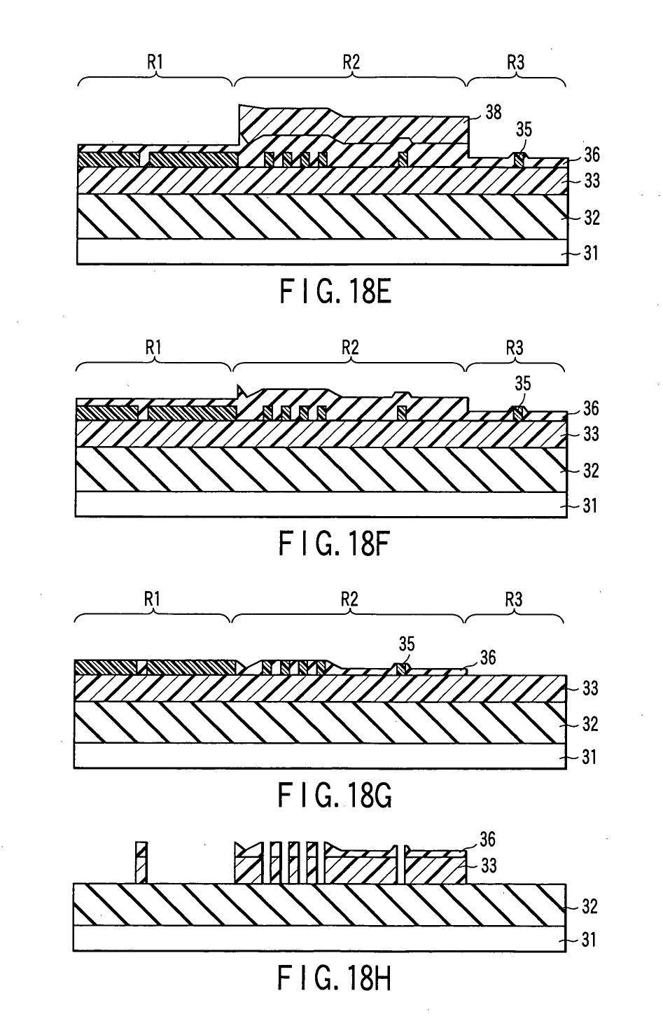

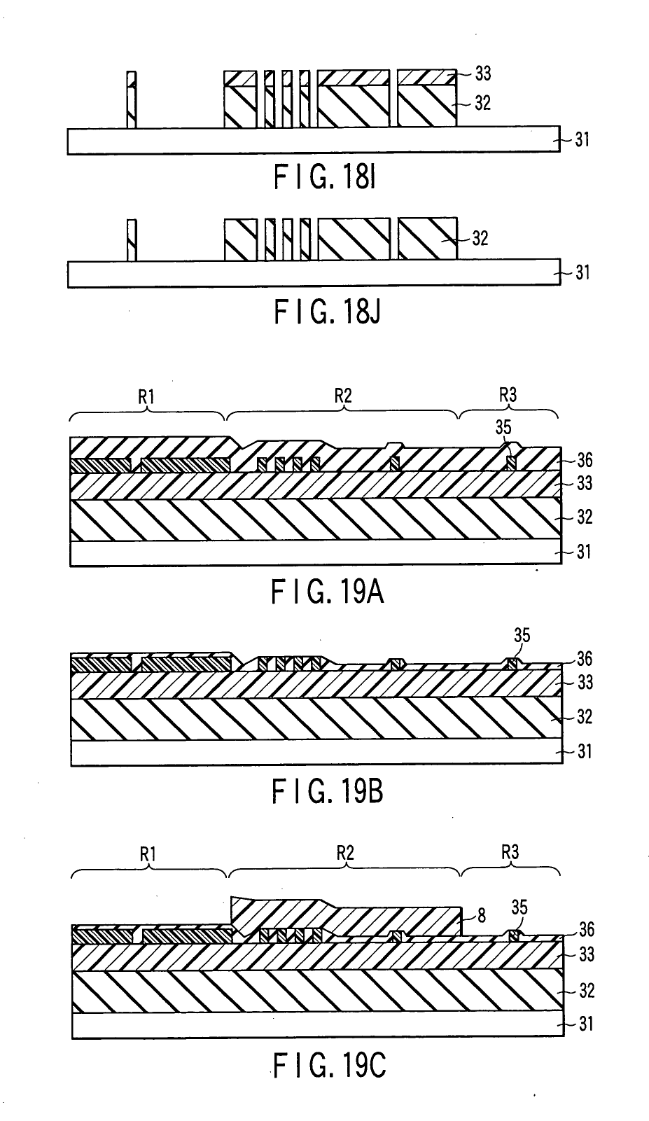

FIG. 18A to FIG. 18J are cross-sectional views showing the process of manufacturing a semiconductor device according to a 13-th embodiment of the present invention.

As shown in FIG. 18A, a TEOS film (first film) 32 having a thickness of 500 nm is formed on a substrate 31. Thereafter, a polyacenaphthylene film 33 having a thickness of 300 nm is formed on the TEOS film 32 as under-layer film in a manner of being baked after spin coating. A first resist film 35 having a thickness of 85 nm is formed on the carbon film 53. A first resist film 35 is formed on the polyacenaphthylene film 33 to have a thickness of 125 nm using spin coating, and thereafter, pre-baked.

As illustrated in FIG. 18B, the first resist film 35 is exposed using an ArF exposure system, and thereafter, PEB and development are carried out, and thereby, the pattern of the first resist film 35 is obtained. The pattern of the first resist film 35 has regions R1 to R3. In the region R2, the pattern of the first resist film 35 satisfies the following equation. That is, the relation between one side length y (μm) of the maximum square region having 90% or more coverage and one side length x (μm) of the maximum square region having 10% or less coverage satisfies the equation (1). In the regions R1 and R3, the pattern of the first resist film 35 does not satisfy the equation (1). In the region R1, the pattern of the first resist film 35 is a large remaining pattern. In the region R3, the pattern of the first resist film 35 is micro line and space pattern or isolated line.

As depicted in FIG. 18C, a water-soluble silicone film 36 is formed on the entire surface to have a thickness of 500 nm using spin coating.

In the region R1, the water-soluble silicone film 36 on the first resist film 35 is formed thicker than that in the region R2. In the region R3, the water-soluble silicone film 36 on the first resist film 35 is formed thinner than that in the region R2.

As seen from FIG. 18D, a second resist film 38 having a thickness of 300 nm is formed on the water-soluble silicone film 36. The second resist film 38 is formed in a manner of being pre-baked after a solution is coated using spin coating. The second resist film 38 is a positive i-line resist. Further, the second resist film 38 is exposed and developed so that a pattern of the second resist film 38 is obtained. In the pattern of the second resist film 38, the large remaining portion in the pattern of the first resist film 35 must be removed.

As shown in FIG. 18E, the water-soluble silicone film 36 is etched by plasma of CF₄/O₂ mixed gas using the second resist film 38 as a mask. The depth of etching the water-soluble silicone film 36 is nearly 50 nm. In the region R1, the water-soluble silicone film 36 remains on the first resist film 35; on the other hand, in the region R3, the upper surface of the first resist film 35 is exposed.

As illustrated in FIG. 18F, the remaining second resist film 38 and the first resist film 35 in the region R3 are removed using oxygen (O₂) plasma.

As depicted in FIG. 18G, the water-soluble silicone film 36 is etched back using plasma of CF₄/O₂ mixed gas. In the region R3, the water-soluble silicone film 36 is removed. In the region R2 (R3?), the upper surface of the first resist film 35 is exposed, and the water-soluble silicone film 36 remains between patterns. In the portion where the water- soluble silicone film 36 remains, the water-soluble silicone film 36 has a thickness always exceeding the minimum requirement, that is, 50 nm for etching the polyacenaphthylene film 33 having a thickness of 500 nm.

As seen from FIG. 18H, the polyacenaphthylene film 33 is patterned using oxygen plasma.

As shown in FIG. 18I, the TEOS film 32 is etched using the polyacenaphthylene film 33 as a mask.

As illustrated in FIG. 18J, the pattern of the polyacenaphthylene film 33 is subjected to ashing using oxygen plasma, and thereafter, removed. The processes described above are carried out, and thereby, a desired pattern of the TEOS film 32 is obtained.

In the 13-th embodiment, the first anti-reflection film corresponding to the first resist film is not used. However, even if the first anti-reflection film is used, the present invention does not depart from the scope of the invention. In the 13-th embodiment, the second anti-reflection film corresponding to the second resist film is not used. However, even if the second anti-reflection film is used, the present invention does not depart from the scope of the invention.

(14-th Embodiment)

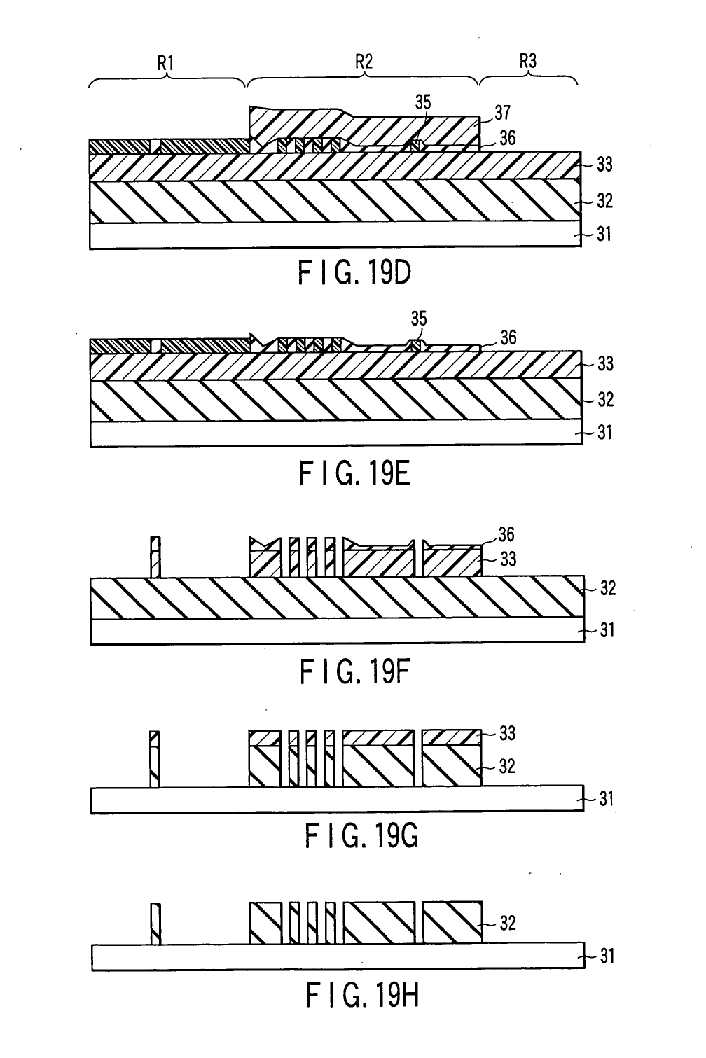

FIG. 19A to FIG. 19H is cross-sectional views showing the process of manufacturing a semiconductor device according to a 14-th embodiment of the present invention.

In the 14-th embodiment, the processes described in FIG. 18A to FIG. 18C are carried out to form the structure shown in FIG. 19A. The pattern of the first resist film 35 has regions R1 to R3. In the region R2, the pattern of the first resist film 35 satisfies the following equation. That is, the relation between one side length y (μm) of the maximum square region having 90% or more coverage and one side length x (μm) of the maximum square region having 10% or less coverage satisfies the equation (1). In the regions R1 and R3, the pattern of the first resist film 35 does not satisfy the equation (1). In the region R1, the pattern of the first resist film 35 is a large remaining pattern. In the region R3, the pattern of the first resist film 35 is an isolated line pattern.

In the region R1, the water-soluble silicone film 36 on the first resist film 35 is formed thicker than that in the region R2. In the region R3, the water-soluble silicone film 36 on the first resist film 35 is formed thinner than that in the region R2.

As illustrated in FIG. 19G, the water-soluble silicone film 36 is etched back using plasma of CF₄/O₂ mixed gas. In the region R1, the water-soluble silicone film 36 remains on the first resist film 35. In the regions R2 and R3, the upper surface of the first resist film 35 is exposed.

As depicted in FIG. 19C, the second resist film 38 is formed in the region R2 like the 13-th embodiment. As seen from FIG. 19D, the water-soluble silicone film 36 is etched by the plasma of the CF₄/O₂ mixed gas using the second resist film 38 as a mask. The depth of etching the water-soluble silicone film 36 is nearly 50 nm. By doing so, in region R1, the upper surface of the first resist film 35 is exposed.

As shown in FIG. 19E, the residual film of the second resist film 38 is removed by thinner treatment. As illustrated in FIG. 19F, the first resist film 35 is removed using oxygen plasma. Then, the polyacenaphthylene film 33 is patterned using oxygen plasma.

As depicted in FIG. 19G, the TEOS film 32 is etched using the pattern of the polyacenaphthylene film 33 as a mask. As seen from FIG. 19H, the pattern of the water-soluble silicone film 36 is subjected to ashing using oxygen plasma. The processes described above are carried out, and thereby, a desired pattern of the TEOS film 32 is obtained.

In the 14-th embodiment, the first anti-reflection film corresponding to the first resist film is not used. However, even if the first anti-reflection film is used, the present invention does not depart from the scope of the invention. In the 14-th embodiment, the second anti-reflection film corresponding to the second resist film is not used. However, even if the second anti-reflection film is used, the present invention does not depart from the scope of the invention.

(Modification example)

In the foregoing embodiments, the TEOS film is used as the first film; however, in the present invention, the kind of the first film is not limited to the TEOS film. For example, a polysilicon film, aluminum film, various metal films, semiconductor film and insulating film may be used.

In the foregoing embodiments, the polyacenaphthylene film is used as the under-layer film; however, in the present invention, the kind of the under-layer film is not limited to the polyacenaphthylene film. For example, a novolak resin film, polyimide film, polyallylene film and polyallylene ether may be used.

In the foregoing embodiments, an ArF resist and i-line resist are used as resist films 35 and 38; however, the present invention is not limited to these ArF and i-line resists. The following resists may be used as resist films 35 and 38, and exposure systems (aligners) corresponding to these resists. The resists are an ArF resist, g-line resist, i-line resist, KrF resist, F2 resist, electron beam resist, X-ray resist, EUV resist, inprint lithography resist, etc.

In the foregoing embodiments, the water-soluble silicone film 36 is used as the mask layer; however, in the present invention, the mask layer film is not limited to the water-soluble silicone film. Only materials fully removing the resist film 35 are applicable to the present invention. For example, SOG film using solvent, which does not dissolve the resist film 35 is usable.

In the foregoing embodiments, RIE is employed as the etch-back process; however, the present invention is not limited to the embodiment. For example, the following materials may be used as the etching mask material. The materials are irradiation sensitive poly-silane, irradiation sensitive poly-germane, irradiation sensitive poly-stannane, irradiation sensitive poly-silazane, irradiation sensitive poly-siloxane, irradiation sensitive poly-carbosilanen, irradiation sensitive disilanylene-π-electron polymer, and copolymers consisting of two or more compounds. In addition, the materials are novolak resin containing silicon atom in benzene ring substituent and poly-hydroxystyrene resin containing silicon atom in benzene ring substituent or mixtures of any of these compounds and irradiation sensitive substance. The following development is carried out with respect to the materials given above. More specifically, in place of etch back, energy beam (light beam, electron beam or ion beam) is irradiated to expose the etching mask material. Thereafter, development is carried out so that the etching mask material remains between patterns of resist film. The inventors have already filed the method of leaving the etching mask material by U.S. pat. appln. Ser. No. 10/419,921. Materials, which do not fully remove the pattern of the resist film, must be used.

In the sixth and seventh embodiments, the second resist film 38 is removed, and thereafter, the second anti-reflection film 37 is removed so that the polyacenaphthylene film 33 is patterned. For example, the removal of the second resist film 38 and the second anti-reflection film 37 and patterning of the polyacenaphthylene film 33 may be collectively carried out using oxygen plasma.

In the eighth embodiment, the second resist film 38 is removed, and thereafter, the second anti-reflection film 37 is removed so that the carbon film 53 is patterned. For example, the removal of the second resist film 38 and the second anti-reflection film 37 and patterning of the carbon film 53 may be collectively carried out using oxygen plasma.

In the 14-th embodiment, the removal of the residual film of the second resist film 38, the removal of the first resist film and patterning of the polyacenaphthylene film 33 are separately carried out. In this case, the foregoing removal and patterning may be serially carried out. For example, oxygen plasma is used, and thereby, it is possible to serially carry out the removal of the residual film of the second resist film 38, the removal of the first resist film and patterning of the polyacenaphthylene film 33.

In order to etch back the surface of the mask layer (water-soluble silicone film 36, SOG film 36), wet etching, dry etching, chemical mechanical polishing or-combination of two processes or more may be used. In order to etch back the surface of the mask layer (water—soluble silicone film 36, SOG film 36), it is preferable to use etching condition in which the etch-back rate of the mask layer is nearly equal to that of the first resist film. In particular, if chemical mechanical polishing is used, the step of the mask material is reduced; therefore, the limitation shown in mathematical equations 1 to 7 is relaxed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern forming method comprising:
forming a first layer on a semiconductor substrate;
forming a resist layer on the first layer;
patterning the resist layer to form a first patterning layer having several patterns;
slimming or thickening a pattern width of the first patterning layer;
forming a second patterning layer between patterns of the first patterning layer; and
patterning the first patterning layer using the second patterning layer as a mask.

2. The method according to claim 1, wherein slimming or thickening is to carry out one or more treatment selected from a group including dry etching, heat treatment, chemical treatment and energy beam irradiation.

3. The method according to claim 2, wherein the dry etching is carried out in an etching gas atmosphere, and the etching gas is one or more gas selected from a group including CF₄ gas, HBr gas and O₂ gas.

4. The method according to claim 2, wherein the chemical treatment is one or more treatment selected from a group including ozone water treatment, hydrogen peroxide water treatment, silane coupling agent treatment and optical catalyst water treatment.

5. The method according to claim 1, wherein the energy beam irradiation is one or more irradiations selected from a group including electron beam irradiation, laser beam irradiation and ultraviolet beam irradiation.

6. The method according to claim 1, further comprising:
patterning a material formed at the under-layer as the patterned first layer as a mask.

7. A pattern forming method comprising:
forming a first resist film on a first film;
patterning the first resist film, in a region where a pattern of the first resist film is formed, the relation between one side length y (μm) of the maximum square region where the first resist film has 90% or more coverage and one side length x (μm) of the maximum square region where the same has 10% or less coverage satisfying the following equation y<84.29+44.63×10³×e^{-X}/17.80;
forming a mask layer on the first film using spin coating, the mask layer covering the first resist film;
etching back the surface of the mask layer to expose the upper surface of the first resist film;
removing the first resist film after the first resist film is exposed; and
etching the first film using the mask layer as a mask.

8. The method according to claim 7, wherein a first anti-reflection film is formed on the first film before the first resist film is formed.

9. The method according to claim 7, wherein a treatment for providing solvent resistant to the first resist film is carried out.

10. The method according to claim 9, wherein the treatment includes at least one of electron beam irradiation, light beam irradiation, ion irradiation and radical irradiation.

11. The method according to claim 7, wherein the etch-back is carried out using at least one of wet etching, dry etching and chemical mechanical polishing.

12. The method according to claim 7, wherein the etch-back is carried out under etching condition that the etch-back rate of the mask layer is nearly equal to that of the first resist film.

13. The method according to claim 7, wherein an under-layer film is formed on the first film before the first resist film is formed.

14. A pattern forming method comprising:
forming a first resist film on a first film;
patterning the first resist film;
forming a mask layer on the first film using spin coating, the mask layer covering the first resist film;
etching back the surface of the mask layer to expose the upper surface of the first resist film;
forming a second resist film covering the mask layer on the first film after the first resist film is exposed;
patterning the second resist film;
etching the mask layer using the patterned second resist film as a mask removing the first and second resist films after the mask layer is etched; and
patterning the first film using the etched mask layer as a mask after the removal of the first and second resist films or simultaneously with the removal.

15. The method according to claim 14, wherein after the second resist film is patterned, in a region where the pattern of the first resist film and the second resist film are stacked, the relation between one side length y (μm) of the maximum square region where the first resist film has 90% or more coverage and one side length x (μm) of the maximum square region where the same has 10% or less coverage satisfying the following equation y<84.29+44.63×10³×e^{-X}/17.80.

16. The method according to claim 15, wherein a stacked region of the first and second resist films and a thick film region where the mask layer is formed thicker than the mask layer in the stacked region are set,
the second resist film is patterned so that no second resist film is formed on the mask layer of the thick film region,
the etch-back of the mask layer is carried out to expose the upper surface of the first resist film of the stacked region and not to expose the upper surface of the first resist film of the thick film region, and
the mask layer is etched to expose the upper surface of the first resist film of the thick film region.

17. The method according to claim 14, wherein a first anti-reflection film is formed on the first film before the first resist film is formed.

18. The method according to claim 14, wherein a second anti-reflection film is formed on the mask layer before the first resist film is formed.

19. The method according to claim 14, wherein a film containing one or more elements selected from silicon and metal elements is formed before the upper surface of the first resist film is exposed

20. The method according to claim 14, wherein a treatment for providing solvent resistant to the first resist film is carried out.

21. The method according to claim 20, wherein the treatment for providing solvent resistant to the first resist film includes one or more types of irradiation selected from a group including electron beam irradiation, light beam irradiation, ion irradiation and radical irradiation.

22. The method according to claim 14, wherein the mask layer is etched back using at least one of wet etching, dry etching and chemical mechanical polishing.

23. The method according to claim 14, wherein the etch-back is carried out under an etching condition in which the etch-back rate of the mask layer is nearly equal to that of the first resist film.

24. The method according to claim 14, wherein an under-layer film is formed on the first film before the first resist film is formed.

25. The method according to claim 24, wherein the under-layer film has an anti-reflection function to the pattern of the first resist film.

26. The method according to claim 14, wherein the mask layer contains one or more elements selected from silicon and metal elements.

27. A pattern forming method comprising:
forming a first resist film on a first film;
patterning the first resist film;
forming a mask layer on the first film using spin coating, the first resist film covering the first resist film;
forming a second resist film covering the mask layer on the first film;
patterning the second resist film;
etching the mask layer using the patterned second resist film as a mask;
removing the second resist film after the mask layer is etched;
etching back the surface of the mask layer to expose the upper surface of the first resist film after the second resist film is removed;
removing the exposed first resist film; and
patterning the first film using the etched mask layer as a mask after the removal of the exposed first resist film or simultaneously with the removal.

28. The method according to claim 27, wherein the relation between one side length y (μm) of the maximum square region where the first resist film has 90% or more coverage and one side length x (μm) of the maximum square region where the same has 10% or less coverage satisfies the following equation y<84.29+44.63×10³×e^{-X}/17.80.

29. The method according to claim 27, wherein after the second resist film is patterned, in a region where the pattern of the first resist film and the second resist film are stacked, the relation between one side length y (μm) of the maximum square region where the first resist film has 90% or more coverage and one side length x (μm) of the maximum square region where the same has 10% or less coverage satisfying the following equation y<84.29+44.63×10³×e^{-X}/17.80.

30. The method according to claim 29, wherein a stacked region of the first and second resist films and a thick film region where the mask layer is formed thicker than the mask layer in the stacked region are set, and
the second resist film is patterned so that no second resist film is formed on the mask layer of the thick film region.

31. The method according to claim 27, wherein a second anti-reflection film is formed on the mask layer before the first resist film is formed.

32. The method according to claim 27, wherein a treatment for providing solvent resistance to the first resist film is carried out.

33. The method according to claim 32, wherein the treatment for providing solvent resistance to the first resist film includes at least one of electron beam irradiation, light beam irradiation, ion irradiation and radical irradiation.

34. The method according to claim 27, wherein the mask layer is etched back using one or more processes selected from wet etching, dry etching and chemical mechanical polishing.

35. The method according to claim 27, wherein the mask layer is etched back out under an etching condition in which the etch-back rate of the mask layer is nearly equal to that of the first resist film.

36. The method according to claim 27, wherein an under-layer film is formed on the first film before the first resist film is formed.

37. The method according to claim 36, wherein the under-layer film has an anti-reflection function to the pattern of the first resist film.

38. The method according to claim 14, wherein the mask layer contains one or more elements selected from silicon and metal elements.

39. A method of manufacturing a semiconductor device using the pattern forming method described in claim 7.
